(19) United States
(12) Patent Application Publication
(10) Pub. No.: US 2025/0197597 A1
(43) Pub. Date: Jun. 19, 2025

(54) A PLASTIC PRODUCT

(71) Applicant: DataLase Ltd., Widnes Cheshire (GB)

(72) Inventors: Martin Walker, Widnes Cheshire (GB); Jason Tweedie, Widnes Cheshire (GB)

(21) Appl. No.: 18/844,819

(22) PCT Filed: Mar. 10, 2023
(86) PCT No.: PCT/EP2023/056206

§ 371 Date: Sep. 6, 2024

(30) Foreign Application Priority Data
Mar. 11, 2022 (EP) 22161658.4

(51) Int. Cl. C08K 3/22; B41J 2/435; C08J 7/12; C08K 3/34; C08K 3/38; C08K 5/18

(52) U.S. Cl. CPC C08K 3/22; C08J 7/123; C08K 3/346; C08K 3/38; C08K 5/18; B41J 2/435; C08J 2323/06; C08J 2323/12; C08J 2367/02; C08K 2003/2231; C08K 2003/2255; C08K 2003/387

(57) ABSTRACT

The present invention relates to a plastic product formed of a plastic material having a colour-forming compound incorporated therein. The present invention further relates to a method of production of said plastic product using the colour-forming compound, as well as a method of forming a mark or image on the plastic product.

### FIELD OF THE INVENTION

The present invention relates to the incorporation of colour-forming compound into plastic products, and to plastic products having colour-forming compounds incorporated therein.

### BACKGROUND OF THE INVENTION

The use of laser-reactive compositions comprising colour-forming compounds to produce human and/or machine-readable images and display variable information on substrates is known in coating compositions. Typically, following application of such a laser-reactive composition to a substrate via a coating composition, an image(s) can be formed upon application of appropriate laser-applied radiation to the composition. The radiation affects the colour-forming compound of the composition, causing it to display colour, or change colour, in the areas of the composition to which the radiation has been applied, such that an image(s) is formed.

In many different industries, laser-reactive compositions are applied to the exterior of substrates as coating compositions to provide variable information. For example, laser-reactive coating compositions have been used to provide variable information on labels or films which are attached to plastic products such as plastic packaging. The laser-reactive coating compositions are applied to the exterior of the label. These labels are typically formed of a different plastic to the plastic packaging, or even a non-plastic material such as paper, and constitute a separate article to the plastic packaging itself. This is clearly demonstrated by a wrap-around film label or adhesive plastic label used with plastic bottles for beverages. Routinely, upon disposal of such plastic packaging, the disposal processes for the packaging and the label differ and are incompatible. Either two different recycling processes are required for the separate articles (packaging and label), one or other of the articles is not recyclable, or in some instances, the two articles have become bonded following application of the label to the packaging and cannot be separated or are difficult to separate such that suitable recycling processes cannot be achieved or are difficult to achieve. From a sustainability perspective, this is far from ideal.

It is therefore desirable to provide a sustainable solution to the above problems that enables effective formation of distinct and discernible human and/or machine-readable image(s) on a plastic product, such as plastic packaging, to provide variable information, whilst helping to reduce waste and streamlining disposal and recycling operations.

### SUMMARY OF THE INVENTION

According to a first aspect of the present invention, there is provided a plastic product formed of a plastic material having a colour-forming compound incorporated therein, wherein the plastic product is a plastic preform or plastic packaging.

According to a second aspect of the present invention, there is provided a plastic product formed of a plastic material having a colour-forming compound incorporated therein, the plastic product having been produced by bringing the colour-forming compound into contact with a plastic material to form a plastic material having the colour-forming compound incorporated therein, and forming the plastic material having the colour-forming compound incorporated therein into the plastic product, wherein the plastic product is a plastic preform or plastic packaging.

According to a third aspect of the present invention, there is provided a plastic product formed of a plastic material having a colour-forming compound incorporated therein, the plastic product having been produced by forming a plastic material having the colour-forming compound incorporated therein into a plastic product, wherein the plastic product is a plastic preform or plastic packaging.

According to a fourth aspect of the present invention, there is provided a method of producing a plastic product formed of a plastic material having a colour-forming compound incorporated therein, the method comprising bringing the colour-forming compound into contact with a plastic material to form a plastic material having the colour-forming compound incorporated therein, and forming the plastic material having the colour-forming compound incorporated therein into the plastic product, wherein the plastic product is a plastic preform or plastic packaging.

According to a fifth aspect of the present invention, there is provided a method of producing a plastic product formed of a plastic material having a colour-forming compound incorporated therein, the method comprising forming a plastic material having the colour-forming compound incorporated therein into a plastic product, wherein the plastic product is a plastic preform or plastic packaging.

According to a sixth aspect of the present invention, there is provided a use of a colour-forming compound in the production of a plastic material having the colour-forming compound incorporated therein, or in the production of a plastic product having the colour-forming compound incorporated therein, wherein the plastic product is a plastic preform or plastic packaging.

According to a seventh aspect of the present invention, there is provided a mixture comprising:
(i) a colour-forming compound; and
(ii) a plastic material.

According to an eighth aspect of the present invention, there is provided a plastic product displaying a mark or image, wherein the plastic product is formed of a plastic material having a colour-forming compound incorporated therein, and wherein the plastic product is a plastic preform or plastic packaging.

According to a ninth aspect of the present invention, there is provided a plastic product displaying a mark or image, said product obtainable by applying radiation to a plastic product having a colour-forming compound incorporated therein such that the mark or image is formed where the radiation is applied to the plastic product, wherein the plastic product is a plastic preform or plastic packaging.

According to a tenth aspect of the present invention, there is provided a method of forming a mark or image on a plastic product, the method comprising exposing the plastic product to radiation to form the mark or image where the radiation is applied, wherein the plastic product is formed of a material having a colour-forming compound incorporated therein, and wherein the plastic product is a plastic preform or plastic packaging.

According to a further aspect of the present invention, there is provided a use of a colour-forming compound in the formation of a mark or image on a plastic product formed of a plastic material having the colour-forming compound incorporated therein, wherein the plastic product is a plastic preform or plastic packaging.

According to a further aspect of the present invention, there is provided a plastic material having a colour-forming compound incorporated therein.

According to a further aspect of the present invention, there is provided a method of forming a plastic material having a colour-forming compound incorporated therein, the method comprising bringing the colour-forming compound into contact with a plastic material.

According to a further aspect of the present invention, there is provided a method of producing a plastic preform, and optionally a plastic bottle, the plastic preform or plastic bottle being formed of a plastic material having a colour-forming compound incorporated therein, the method comprising bringing the colour-forming compound into contact with a plastic material to form a plastic material having the colour-forming compound incorporated therein, and forming a plastic preform from the plastic material having the colour-forming compound incorporated therein, and optionally forming the plastic preform into a plastic bottle.

According to a further aspect of the present invention, there is provided a method of producing a plastic preform, and optionally a plastic bottle, the plastic preform or plastic bottle being formed of a plastic material having a colour-forming compound incorporated therein, the method comprising forming a plastic preform from a plastic material having the colour-forming compound incorporated therein, and optionally forming the plastic preform into a plastic bottle.

### DETAILED DESCRIPTION OF THE INVENTION

It has been surprisingly and advantageously found that the incorporation of colour-forming compounds into plastic products enables the effective formation of a distinct and discernible human and/or machine-readable mark(s) or image(s) upon application of appropriate radiation, preferably from a laser source(s), lamp or LED, thereto. The resulting imaged plastic products can thus display any required variable information as a mark(s) or image(s) from within and on the plastic product without the need for any additionally attached substrate or material, such as a separate label or film. It is noted that the formation of mark(s) or image(s) on plastic products through the application of radiation, preferably using a laser source(s), lamp or LED, is known. Mark or image formation may be achieved via techniques such as ablation, engraving or foaming of the plastic material used to form the plastic product. However, problems exist with respect to the effectiveness of the mark(s) or image(s) formed. The mark(s) or image(s) may lack opacity such that they are not effective and distinct. The present invention provides effective mark(s) or image(s) formation, and overcomes the problems detailed above-streamlining disposal operations and avoiding the need for separate recycling processes for the plastic product and any additionally attached substrate or material. Only one recycling process is required for proper disposal of the plastic product. Furthermore, as the colour-forming compound is already incorporated in the plastic products of the present invention for the production of variable information thereon, no additionally applied ink, coating, transfer, pigment or dye is required to be applied to the exterior of a product by, for example, jet, spray, screen, or overprint application techniques, for the purposes of providing variable information.

It is surprising and advantageous that the colour-forming compounds can be used to create the plastic products of the present invention. Generally, the formation, manufacture or conversion of plastic products, as well as any antibacterial, antimicrobial or antiviral processes to which the formed plastic products may be exposed, require high-temperature processing conditions. It is therefore highly surprising and advantageous that, under such high-temperature processing conditions, the colour-forming compounds do not form a colour in the plastic product that prevents the subsequent production of an effective and discernible mark or image, either by the colour-forming compound itself or through the marking of the plastic product via techniques such as ablation, engraving or foaming as discussed above. The formation of the mark or image on plastic products of the present invention is achieved following specific application of radiation to the plastic product, following its production. Such advantageous effects have not been achieved to date for colour-forming compounds known and previously used in laser marking.

According to a first aspect of the present invention, there is provided a plastic product formed of a plastic material having a colour-forming compound incorporated therein.

All features of the first aspect of the present invention, including all preferred and optional features detailed below, are applicable to all other aspects described herein. In the same manner, all features of all other aspects described herein, including preferred and optional features of each aspect, are applicable to the first aspect of the present invention.

The plastic material forming the plastic product of the present invention may be any suitable plastic material. The plastic material may be selected from any suitable commercially available plastic material. These will be well known to a skilled person.

The plastic material may comprise a polymer, copolymer, or combination thereof as the main component. The plastic material may comprise poly(ethylene-vinyl acetate) or ethylene-vinyl acetate (EVA) copolymers; poly(ethylene acrylate) copolymers; acrylics; polyvinyl butyral; polyolefins such as polybutene, polyethylene, and polypropylene, including both low-density (LDPE) and high-density (HDPE) polyethylene; polyamides such as ethylene diamine and hexamethylene diamine; nylons; polyesters including poly(lactic acid) (PLA), polyethylene terephthlate (PET), polyester resins, polybutylene terephthalate (PBT), poly cyclohexylenedimethylene terephthalate glycol-modified (PCTG), polyhydroxyalkanoates (PHA), and poly(glycolic acid) (PGA); polyurethanes; acrylic and styrene-acrylate copolymers; polystyrene (PS); polycaprolactones; polycarbonates; fluoropolymers; phenolic resins or phenol formaldehyde resins; epoxy resins; elastomers such as nitrile butadiene rubber, styrene butadiene rubber; silicone rubbers; polypyrrole; ABS (acrylonitrile butadiene styrene); acetals; recycled materials such as polyethylene terephthaltate (r-PET); or combinations thereof.

The plastic material may comprise a blend of one or more of polyethylene terephthalate (PET), polybutylene terephthalate (PBT), poly cyclohexylenedimethylene terephthalate glycol-modified (PCTG), recycled polyethylene terephthalate (r-PET) or polyethylene terephthalate glycol (PET-G), preferably polyethylene terephthalate (PET), with one or more of polyethylene, polypropylene (PP), polycarbonates (PC), polystyrene (PS), poly(ethylene-vinyl acetate) or ethylene-vinyl acetate (EVA) copolymers, and ABS (acrylonitrile butadiene styrene). The plastic material may comprise a blend of one or more of polyethylene terephthalate (PET), polybutylene terephthalate (PBT), poly cyclohexylenedimethylene terephthalate glycol-modified (PCTG), recycled polyethylene terephthalate (r-PET) or polyethylene terephthalate glycol (PET-G), preferably polyethylene terephthalate (PET), with one or more of epoxy resins, polyester resins, phenolic resins or phenol formaldehyde resins, and elastomers such as nitrile butadiene rubber, styrene butadiene rubber.

The plastic material may comprise polyethylene terephthalate (PET), polybutylene terephthalate (PBT), poly cyclohexylenedimethylene terephthalate glycol-modified (PCTG), high density polyethylene (HDPE), polypropylene (PP), polyvinyl chloride (PVC), polyvinylidene chloride (PVDC), polychlorotrifluoroethylene (PCTFE), cyclic olefin copolymer (COC), recycled polyethylene terephthalate (r-PET), polyethylene terephthalate glycol (PET-G), polycarbonates (PC), poly(lactic acid) (PLA), polyethylene terephthlate (PET), polyhydroxyalkanoate (PHA), poly(glycolic acid) (PGA), low density polyethylene (LDPE) and polystyrene (PS), or combinations thereof.

Preferably, the plastic material comprises polyethylene terephthalate (PET), polybutylene terephthalate (PBT), poly cyclohexylenedimethylene terephthalate glycol-modified (PCTG), high density polyethylene (HDPE), polypropylene (PP), polyvinyl chloride (PVC), recycled polyethylene terephthalate (r-PET), low density polyethylene (LDPE), polyethylene terephthalate glycol (PET-G), and polystyrene (PS), or combinations thereof. It will be appreciated by a skilled person that these plastic materials are recyclable, such that the plastic material may be any suitable recyclable plastic material.

More preferably, the plastic material comprises polyethylene terephthalate (PET), polybutylene terephthalate (PBT), poly cyclohexylenedimethylene terephthalate glycol-modified (PCTG), recycled polyethylene terephthalate (r-PET), polyethylene terephthalate glycol (PET-G), low density polyethylene (LDPE), high-density polyethylene (HDPE), and polypropylene (PP), or combinations thereof. More preferably, the plastic material comprises polyethylene terephthalate (PET), high-density polyethylene (HDPE), recycled polyethylene terephthalate (r-PET), polyethylene terephthalate glycol (PET-G), low density polyethylene (LDPE), polypropylene (PP), or combinations thereof. More preferably, the plastic material comprises polyethylene terephthalate (PET), recycled polyethylene terephthalate (r-PET) or polyethylene terephthalate glycol (PET-G). More preferably, the plastic material comprises polyethylene terephthalate (PET).

Examples of commercially available PET and r-PET include PET obtained from Songhan Plastic Technology Co., Ltd. under the name ‘DAK Americas Laser+® B90A PET’ and r-PET obtained from Far Eastern New Century Corporation under the name ‘FENC® Topgreen rPCT’.

The plastic material may further comprise one or more additives. Suitable additives include: pigments which cause the plastic material, and thus the plastic product formed therefrom, to display colour; waxes such as microcrystalline waxes, fatty aide waxes or oxidised fischer-tropsch waxes; UV absorbers; slip additives; lubricants; inhibitors; antioxidants; stabilisers; UV stabilisers; adhesion promotors; plasticisers; light or energy absorbing agents; surfactants; wetting agents; drying promotors; colorants such as pigments; flame retardants; antistatic agents; fillers; tinting agents; fluorescent agents; optical brighteners; oxidising or reducing agents; stabilisers; light stabilising agents such as hindered amines; rheology modifiers such as thickening or thinning agents; matting agents; active clays; anti-settling agents; anti-sagging agents; dispersing agents; surface modification additives; slip additives such as stearates; levelling agents; fillers; humectants; adhesion promotors; acid or base scavenging agents; retarders; defoamers; antifoaming agents; biocides; antimicrobial agents; antiviral agents; antibacterial agents; antifungal agents; antimould agents; germicidal agents; sanitising agents; and other suitable processing additives; or combinations thereof. Typically, of those listed above: one or more of pigments; waxes; plasticisers; antioxidants; UV stabilisers, and fillers; or combinations thereof; are selected and may be present in the plastic material. It will be appreciated that required additives for the plastic materials vary depending on the desired plastic products. Such requirements will be well known to a skilled person. Typically, the one or more additives may be present in the plastic material in an amount of from 0.01 to 35 wt %, such as from 0.02 to 30 wt %, or from 0.05 to 25 wt %, or from 0.1 to 20 wt %. By “wt %” here is meant the weight of the one or more additives with respect to the total weight of the plastic material, i.e. the polymer, copolymer, or combination thereof, and when present, the one or more additives.

It will be appreciated that where the plastic material does not comprise any additives, the plastic material may be formed solely of the polymers, copolymers, or combinations detailed above.

The plastic material of the present invention will typically be known in the art by its polymer, copolymer component. For example, a ‘PET’ or ‘HDPE’ plastic material forming a ‘PET’ or ‘HDPE’ plastic bottle. Accordingly, as detailed herein, the plastic material comprising the polymer, copolymer component such as a plastic material comprising HDPE, LDPE and/or PP, may be considered to be a HDPE, LDPE and/or PP plastic material, which in turn results in a HDPE, LDPE and/or PP plastic product.

In the context of the present invention, the plastic material is not an adhesive material. The plastic material is not a hot melt adhesive.

The plastic product of the present invention may be any suitable product formed from the plastic material.

The plastic product of the present invention is suitable for holding or storing contents, such as liquids or solids. The contents may be pharmaceuticals, food and drink, and non-consumable personal care and household products. The plastic product of the present invention may be empty, or partially or fully filled with contents.

The plastic product of the present invention may be three-dimensional. The plastic product of the present invention may define a volume operable to hold or store contents, such as liquids or solids. The contents may be pharmaceuticals, food and drink, or non-consumable personal care and household products. The plastic product of the present invention may define an internal volume operable to hold or store contents. The plastic product of the present invention may have an outer wall(s), such as an outer wall defining an internal volume operable to hold contents. It will be appreciated that the outer wall(s) may define more than one internal volume (separate or connected) within the plastic product operable to hold contents.

The plastic product is a plastic preform or plastic packaging. Plastic packaging includes plastic lids and plastic containers such as plastic food and/or beverage containers or containers of pharmaceuticals or non-consumable personal care and household products. Suitable examples of plastic containers include plastic boxes, plastic pouches, plastic bottles such as plastic beverage bottles, the plastic blister packaging typically used in the pharmaceutical and tobacco or vaping industries, and clamshell packaging typically used in the food industry. In the context of the present invention, the plastic products may also be multi-layer plastic products, for example, multi-layer plastic preforms, containers or bottles having at least one layer formed of the plastic material as detailed herein, but also further comprising an additional layer(s) such as a barrier layer or additional protective layer. Such multi-layer plastic products may be formed by multi-shot technology such as multi-shot injection molding (typically for multi-layer plastic bottles), or other methods, for example, by thermoforming, lidding and heat-sealing in the formation of blister packaging. It will be appreciated that in the context of the present invention, the plastic product is a uniformly formed plastic product, i.e. uniformly formed of the same plastic material(s). The plastic product includes plastic products as described herein having additional plastic components associated therewith, such as plastic bottles may have plastic lids associated therewith. The plastic product also includes plastic products as described herein having additional non-plastic components associated therewith, such as for example a metal, aluminium foil or paper sealing layer (lidding) in blister packaging. The plastic products of the present invention thus include any plastic product formed of the plastic material as described herein, including its closure, pump, cap, spout, handle, lid or cover.

The plastic products of the present invention may be used to store, hold, transport and distribute goods such as pharmaceuticals, food and drink, and non-consumable personal care and household products.

Preferably, the plastic product is a plastic preform or a plastic container. Preferably, the plastic product is a plastic container. Preferably, the plastic product is a plastic box, plastic pouch, plastic bottle, plastic blister packaging, or plastic clamshell packaging. More preferably, the plastic product is a plastic box, plastic pouch, or plastic bottle. More preferably, the plastic product is a plastic bottle.

Preferably, in the context of the present invention, plastic packaging does not include plastic films or labels, i.e. plastic packaging refers to plastic packaging other than plastic films or labels.

By “plastic preform” is meant a plastic article that is an intermediate product in a production method for a plastic product, typically a plastic bottle. This is a well-known term in the art. The plastic preform is subsequently formed, typically by blow moulding, into a plastic product, such as a plastic bottle.

The plastic material forming the plastic product of the invention has a colour-forming compound incorporated therein. The colour-forming compound enables the formation of a distinct mark or image, upon application of radiation to the plastic product in which it is incorporated. It is surprising and advantageous that the mark or image may be formed through the specific application of radiation to the plastic product following processing and manufacture thereof and that the high-temperature conditions of processing and manufacture do not cause colour formation that prevents a distinct and effective mark or image being formed.

The colour-forming compound may be selected from: an inorganic hydrate; potassium bicarbonate; an oxyanion of a multivalent metal, or an oxyacid, and/or hydrate thereof; kaolin; a leuco dye; a diacetylene; or combinations thereof. Preferably, the colour-forming compound may be selected from: an inorganic hydrate; potassium bicarbonate; an oxyanion of a multivalent metal, or an oxyacid, and/or hydrate thereof; calcined kaolin; a leuco dye; a diacetylene; or combinations thereof. Preferably, the colour-forming compound is selected from an oxyanion of a multivalent metal, or an oxyacid, and/or hydrate thereof; calcined kaolin; and a diacetylene; or combinations thereof.

More preferably, the colour-forming compound is selected from: sodium molybdate dihydrate; ammonium pentaborate tetrahydrate; ammonium pentaborate octahydrate; potassium bicarbonate; ammonium octamolybdate; kaolin; a leuco dye; a diacetylene; or combinations thereof. More preferably, the colour-forming compound is selected from: sodium molybdate dihydrate; ammonium pentaborate tetrahydrate; ammonium pentaborate octahydrate; potassium bicarbonate; ammonium octamolybdate; calcined kaolin; a leuco dye; a diacetylene; or combinations thereof. More preferably, the colour-forming compound is selected from ammonium octamolybdate; calcined kaolin; and a diacetylene; or combinations thereof.

Without being bound by theory, when the colour-forming compound is selected to be an inorganic hydrate, for example, sodium molybdate dihydrate or ammonium pentaborate tetrahydrate or ammonium pentaborate octahydrate, the present inventors consider that the inorganic hydrate, for example sodium molybdate dihydrate or ammonium pentaborate tetrahydrate or ammonium pentaborate octahydrate, facilitate the formation of colour, and thus a mark or image, on the plastic products through dehydration (thermal decomposition) to a dehydrated form following application of radiation thereto, preferably from a laser source(s), lamp or LED. The present inventors consider that the off-gassing or outgassing of water vapour (‘foaming’) from the inorganic hydrate, for example sodium molybdate dihydrate or ammonium pentaborate tetrahydrate or ammonium pentaborate octahydrate, during dehydration generates microscopic pockets or bubbles within the plastic material of the plastic product resulting in a change in refractive index such that the plastic product displays a colour following application of the radiation thereto. The present inventors consider that this effect enhances the formation of the colour seen when radiation may be applied to a plastic product without the inorganic hydrate, for example sodium molybdate dihydrate or ammonium pentaborate tetrahydrate or ammonium pentaborate octahydrate, incorporated therein. For ammonium pentaborate tetrahydrate or ammonium pentaborate octahydrate, the present inventors also consider the off-gassing or outgassing of ammonia to enhance the ‘foaming’ effect. The colour formed by the inorganic hydrate, for example sodium molybdate dihydrate or ammonium pentaborate tetrahydrate or ammonium pentaborate octahydrate, is white, or a shade thereof, such that the mark or image formed is white in colour, or a shade thereof. When the colour-forming compound is selected to be sodium molybdate dihydrate, the plastic material from which the plastic product is formed preferably comprises polyethylene terephthalate (PET), recycled polyethylene terephthalate (r-PET) or polyethylene terephthalate glycol (PET-G), and more preferably, polyethylene terephthalate (PET).

Without being bound by theory, when the colour-forming compound is selected to be potassium bicarbonate, the present inventors consider that the potassium bicarbonate facilitates formation of colour, and thus a mark or image, following application of a radiation thereto, preferably from a laser source(s), lamp or LED, through off-gassing or outgassing of carbon dioxide generating microscopic pockets or bubbles within the plastic material of the plastic product resulting in a change in refractive index such that the plastic product displays a colour following application of the radiation thereto. It may also be the case that some off-gassing or outgassing of water vapour (‘foaming’) from the potassium bicarbonate is seen and generates microscopic pockets or bubbles within the plastic material of the plastic product resulting in a change in refractive index such that the plastic product displays a colour following application of the radiation thereto. The present inventors consider that this effect enhances the formation of the colour seen when radiation may be applied to a plastic product without potassium bicarbonate incorporated therein. The colour formed by potassium bicarbonate is white or a shade thereof, such that the mark or image formed is white in colour, or a shade thereof.

Without being bound by theory, when the colour-forming compound is selected to be kaolin, as discussed below, kaolin may be provided in calcined or non-calcined forms, i.e. calcined kaolin or non-calcined kaolin. The present inventors consider that non-calcined kaolin can facilitate formation of a colour, and thus a mark or image, through loss of water held in the layered silicate material following application of radiation thereto, preferably from a laser source(s), lamp or LED. The present inventors consider that the off-gassing or outgassing of water vapour (‘foaming’) from the layered structure of non-calcined kaolin generates microscopic pockets or bubbles within the plastic material of the plastic product resulting in a change in refractive index such that the plastic product displays a colour following application of the radiation thereto. The present inventors consider that this effect enhances the formation of the colour seen when radiation may be applied to a plastic product without non-calcined kaolin incorporated therein. The colour formed by non-calcined kaolin may be white, or a shade thereof, such that the mark or image formed may be white or a shade thereof. The present inventors consider that calcined kaolin can facilitate formation of a colour, and thus a mark or image, through its absorption of radiation, preferably from a laser source(s), lamp or LED. The present inventors consider that this then causes the localised plastic material surrounding the calcined kaolin to recrystallize to generate colour, and thus a mark or image. The colour formed by calcined kaolin may be white, or a shade thereof, such that the mark or image formed may be white or a shade thereof. The colour formed by calcined kaolin may also be black, grey, brown, or a shade thereof such that the mark or image formed may be black, grey, brown, or a shade thereof. The present inventors consider that this black, grey, brown colour is achieved through the absorption of higher levels of radiation, preferably from a laser source(s), lamp or LED, by the calcined kaolin which causes the localised surrounding plastic material to char, facilitating formation of a colour different to that formed at lower radiation fluence. When the colour-forming compound is selected to be kaolin, either calcined or non-calcined kaolin, the plastic material from which the plastic product is formed preferably comprises polyethylene terephthalate (PET), recycled polyethylene terephthalate (r-PET) or polyethylene terephthalate glycol (PET-G), and more preferably, polyethylene terephthalate (PET).

Without being bound by theory, when the colour-forming compound is selected to be an oxyanion of a multivalent metal or oxyacid, and/or hydrate thereof, the present inventors consider that the oxyanion of a multivalent metal or oxyacid, and/or hydrate thereof facilitates formation of colour, and thus a mark or image, on the plastic products through thermal decomposition of the oxyanion of a multivalent metal or oxyacid, and/or hydrate thereof. Accordingly, in the context of the present invention, if the colour-forming compound is an oxyanion of a multivalent metal or oxyacid, and/or hydrate thereof, it will be appreciated by a skilled person that the processing conditions used for formation of the plastic product may be below the thermal decomposition temperature of the oxyanion of a multivalent metal or oxyacid, and/or hydrate thereof such that the colour-forming compound does not prematurely form colour during production of the plastic product and prevent the subsequent formation of a mark or image on the resulting plastic product. Thermal decomposition of the oxyanion of a multivalent metal or oxyacid, and/or hydrate thereof occurs from 80 to 700° C., or from 80 to 500° C., such as from 100 to 500° C., such as from 150 to 400° C., or even from 200 to 300° C. around 250° C. (decomposition temperature). The decomposition temperature of ammonium octamolybdate (AOM) is 275° C. Accordingly, when the colour-forming compound is selected to be an oxyanion of a multivalent metal of oxyacid, and/or hydrate thereof, the plastic material used to form the plastic product may be selected so as to require a processing temperature of lower than the decomposition temperature of the oxyanion of a multivalent metal, or oxyacid, and/or hydrate thereof, i.e. the plastic material has a melting temperature lower than the decomposition temperature of the oxyanion of a multivalent metal or oxyacid and/or hydrate thereof, for example HDPE, LDPE and/or PP. When the colour-forming compound is an oxyanion of a multivalent metal or oxyacid, and/or hydrate thereof, preferably the plastic material used to form the plastic product is processed at a temperature lower than the temperature of thermal decomposition (decomposition temperature) of the oxyanion of a multivalent metal or oxyacid, and/or hydrate thereof. When the colour-forming compound is an oxyanion of a multivalent metal or oxyacid, and/or hydrate thereof, preferably the plastic material used to form the plastic product comprises HDPE, LDPE or PP, or combinations thereof. The colour formed by the oxyanion of a multivalent metal, or oxyacid, and/or hydrate thereof, for example ammonium octamolybdate (AOM) may be black, dark grey or grey, or a shade thereof, such that the mark or image formed may be black, dark grey or grey, or a shade thereof, in colour. It will be appreciated that if processing of the plastic material used to form the plastic product is carried out at a temperature higher than the temperature of thermal decomposition of the oxyanion of a multivalent metal or oxyacid, and/or hydrate thereof, the colour-forming compound will form colour during processing and the plastic product as a whole will display colour. This would be the case if the plastic material used to form a plastic product having an oxyanion of a multivalent metal or oxyacid, and/or hydrate thereof incorporated therein, was, for example, PET, r-PET or PET-G. In some instances, this is favourable as the subsequent application of radiation, preferably using a laser source(s), lamp or LED, to the plastic product having a ‘background’ colour, typically a black, dark grey, or grey ‘background’ colour, through the marking of the plastic product via techniques such as ablation, engraving or foaming as discussed above would achieve a distinct mark or image, typically a white mark or image, such that the incorporation of a colour-forming compound in the plastic product still achieves the formation of a distinct and discernible mark or image. Preferably, when the colour-forming compound is an oxyanion of a multivalent metal or oxyacid, and/or hydrate thereof, the plastic material used to form the plastic product, and thus the plastic product, comprises HDPE, LDPE, and/or PP. More preferably, when the colour-forming compound is an oxyanion of a multivalent metal or oxyacid and/or hydrate thereof, such as ammonium octamolybdate (AOM), the plastic material comprises HDPE.

Without being bound by theory, when the colour-forming compound is selected to be a diacetylene, the present inventors consider that the diacetylene facilitates formation of colour, and thus a mark or image, on the plastic products through polymerisation using different sources of radiation. This is discussed in more detail below. The colour formed by a diacetylene depends on the diacetylene selected but may typically be blue or red, or a shade thereof, such that the mark or image formed is typically blue or red, or a shade thereof, in colour.

Without being bound by theory, when the colour-forming compound is selected to be a leuco dye, the present inventors consider that the leuco dye facilitates formation of colour, and thus a mark or image, on the plastic products through interaction with an acid-generating agent. This is discussed in more detail below. The colour formed by a leuco dye depends on the leuco dye selected. Leuco dyes forming a broad range of colours are widely available.

In the context of the present invention, the term “incorporated therein” refers to the fact that the colour-forming compound is present within and dispersed throughout the plastic material or the plastic material forming the plastic product. By ‘dispersed throughout’ is meant that colour-forming compound is distributed, preferably homogeneously distributed, throughout the plastic material, and thus the plastic product, and is not just present in one portion or region thereof, for example solely in the portion at which formation of the mark or image is required in the plastic product.

Preferably, the colour-forming compound is present in the plastic material, and thus plastic product, in solid form, and more preferably, particulate form, i.e. as particles of colour-forming compound. Preferably, the colour-forming compound has been introduced into the plastic material during formation of the plastic product in solid form as particles of the colour-forming compound. This is the case when the colour-forming compound is an inorganic hydrate such as sodium molybdate dihydrate or ammonium pentaborate tetrahydrate or ammonium pentaborate octahydrate, kaolin such as calcined kaolin, potassium bicarbonate, a leuco dye, or oxyanion of a multivalent metal, or oxyacid, and/or hydrate thereof, preferably when the colour-forming compound is an inorganic hydrate such as sodium molybdate dihydrate or ammonium pentaborate tetrahydrate or ammonium pentaborate octahydrate, kaolin such as calcined kaolin, potassium bicarbonate, or a leuco dye.

Preferably, the plastic products of the present invention are formed of a plastic material having a colour-forming compound incorporated therein and dispersed throughout. This is applicable for all aspects of the present invention in which a plastic product is mentioned.

As noted above, the colour-forming compound may be selected from: an inorganic hydrate, such as sodium molybdate dihydrate or ammonium pentaborate tetrahydrate or ammonium pentaborate octahydrate; potassium bicarbonate; an oxyanion of a multivalent metal, or an oxyacid, and/or hydrate thereof, such as ammonium octamolybdate (AOM); kaolin such as calcined kaolin; a leuco dye; a diacetylene; or combinations thereof.

‘Inorganic hydrate’ as used herein refers to a hydrate of an inorganic compound having adsorbed or absorbed water and/or water of hydration associated therewith. Suitable inorganic hydrates include, but are not limited to: sodium molybdate dihydrate, ammonium pentaborate tetrahydrate and ammonium pentaborate octahydrate, or combinations thereof.

The colour-forming compound may be an inorganic hydrate. Preferably, the inorganic hydrate may be selected from sodium molybdate dihydrate, ammonium pentaborate tetrahydrate, and ammonium pentaborate octahydrate or combinations thereof. Preferably, the inorganic hydrate is ammonium pentaborate tetrahydrate.

The colour-forming compound may be sodium molybdate dihydrate. Sodium molybdate dihydrate (Na₂MoO₄·2H₂O) is denoted by CAS No. 10102-40-6.

The colour-forming compound may be ammonium pentaborate tetrahydrate. Ammonium pentaborate tetrahydrate ((NH₄)B₅O₈·4H₂O) is denoted by CAS No. 12046-04-7.

The colour-forming compound may be ammonium pentaborate octahydrate. Ammonium pentaborate octahydrate ((NH₄)₂B₁₀O₁₆·8H₂O) is denoted by CAS No. 12046-03-6.

The colour-forming compound may be potassium bicarbonate. Potassium bicarbonate (KHCO₃) is denoted by CAS No. 298-14-6.

The colour-forming compound may be kaolin. Kaolin is an aluminium silicate clay mineral having a layered silicate structure with one tetrahedral sheet of silica (SiO₄) linked through oxygen atoms to one octahedral sheet of alumina (AlO₆) octahedra. Kaolin may be provided in calcined or non-calcined forms, i.e. calcined kaolin or non-calcined (hydrated) kaolin. Calcined kaolin is denoted by CAS 92704-41-1. Non-calcined kaolin is denoted by CAS 1332-58-7. Calcined kaolin has been subjected to a calcination process (typically heating/roasting/firing at temperatures above 900° C.) to remove crystal bound water. For the present invention, preferably calcined kaolin is utilised when the colour-forming compound is selected to be kaolin.

The colour-forming compound may be an oxyanion of a multivalent metal, or oxyacid, and/or hydrate thereof. An oxyanion of a multivalent metal, or an oxyacid, and/or hydrate thereof, may be any suitable oxyanion of a multivalent metal (anionic component) present in conjunction with a cationic counterpart. The use of oxyanions of multivalent metals in compositions is disclosed in U.S. Pat. No. 7,485,403, the content of which is incorporated herein by reference. The anionic component may be an inorganic metal oxyanion compound such as molybdate including di-, tri-, hexa-, hepta-, octa- and deca-molybdates, tungstate, chromate or analogous transition metal compounds also in mixed oxidation states and of mixed inorganic metal oxyanions due to trace elements or any higher concentration ratios. Preferably, the accompanying cationic component is an alkali metal or an alkaline earth metal or ammonium. One example of an oxyanion of a multivalent metal is sodium molybdate. Preferred oxyanions of a multivalent metal are ammonium salts of inorganic metal oxyanion compounds. For example, ammonium paratungstate (APT). Preferably the oxyanion of a multivalent metal or oxyacid, and/or hydrate thereof is an ammonium salt of an oxyanion of a multivalent metal, such as an ammonium salt of an oxyanion of molybdenum, and more preferably, ammonium octamolybdate (AOM), when the colour-forming compound is selected to be an oxyanion of a multivalent metal or oxyacid, and/or hydrate thereof. When the colour-forming compound is AOM, the plastic material used to from the plastic product, and thus the plastic product, preferably comprises LDPE, HDPE and/or PP, preferably HDPE.

The colour-forming compound may be a diacetylene, i.e. a compound comprising a diacetylene moiety

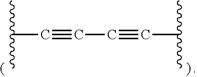 [SMILES: *C#CC#C*]

Diacetylene compounds are well known to a skilled person as compounds capable of forming colour. Upon exposure to radiation, diacetylene compounds typically polymerise and display colour. Typical diacetylene compounds are disclosed for this purpose in WO 2012/114121, the content of which is incorporated herein by reference. Suitable examples are also taught in WO2009/093028, WO2010/001171, WO2010/029329, and WO2013/068729, the content of each of which is incorporated herein by reference. Known methods of synthesis of diacetylene compounds include the formation of a reactive acid chloride and subsequent addition of an amine or alcohol, or the formation of a mixed anhydride and subsequent reactions with an amine or alcohol.

Diacetylene compounds are typically capable of displaying multiple colours. Radiation such as UV radiation, may typically be applied to affect a first colour formation by the diacetylene compound. Near-infrared (NIR) or infrared (IR) radiation may then be applied to effect formation of a second colour of the diacetylene compound. A mark or image may therefore be formed on the product displaying the first colour, the second colour or both the first and second colours.

It will be appreciated by a skilled person that prior to the first colour formation, certain diacetylene compounds (for example, diacetylene compounds of formulas (I) and (II)) may need to be preferentially “activated” (i.e. made capable of forming colour) prior to exposure to the radiation affecting formation of the first colour of the diacetylene compound (e.g. UV radiation). This enables formation of colour by the diacetylene compound to be possible. “Activation” is the process of making the diacetylene compound capable of forming colour, i.e. changing it from an unactivated form (incapable of forming colour) to an activated form (capable of forming colour). If required, activation can be facilitated by exposure of the diacetylene compound to an activation temperature. It will be appreciated by a skilled person that this activation may take place prior to the exposure to the radiation to form the first colour, or alternatively, the diacetylene compound may be activated during this exposure. Preferably, the activation takes place prior to the exposure to the stimulus to effect formation of the first colour. If the activation takes place prior to the exposure to the radiation to form the first colour, the activation temperature is a temperature between ambient temperatures (10 to 35° C.) and the decomposition temperature of the diacetylene compound. The activation temperature may be from 40 to 150° C. Preferably, the activation temperature is from 60 to 140° C., such as from 70 to 140° C. In the context of the present invention, without being bound by theory, the present inventors consider that the diacetylene compound is exposed to the activation temperature during processing and manufacture of the plastic products of the present invention or during the application of radiation to form the first initial colour.

When the colour-forming compound of the present invention is a diacetylene, it may have the following formula (I):

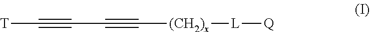

wherein x is from 2 to 12, preferably 2 to 10; L is selected from an amide having the formula:

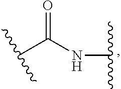 [SMILES: *NC(*)=O]

and an ester having the formula:

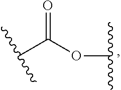 [SMILES: *OC(*)=O]

preferably L is an amide having the formula

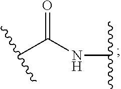 [SMILES: *NC(*)=O]

Q is selected from a C₁₋₂₀ alkyl group and a C₃₋₁₈ cycloalkyl group, preferably Q is selected from cyclopropyl and a —(CH₂)_{y}—CH₃ linear alkyl chain, y being selected from 1 to 20, preferably 5 to 19, and more preferably 5 to 17; and T is selected from hydrogen, a C₁₋₂₀ alkyl group, and —(CH₂)ₓ-L-Q, wherein x, L and Q are as defined above, preferably T is selected from hydrogen, a —(CH₂)_{y}—(CH₃) linear alkyl chain wherein y is as defined above, and —(CH₂)ₓ-L-Q, wherein x, L and Q are as defined above.

It will be appreciated by a skilled person that the diacetylene compound of formula (I) may be either symmetrical or unsymmetrical, i.e. T is —(CH₂)ₓ-L-Q and the values of x, L and Q are the same as those on the other side of the diacetylene moiety (symmetrical), or T is hydrogen, a C₁₋₂₀ alkyl group, or —(CH₂)ₓ-L-Q and the values of x, L and Q are not the same on both sides of the diacetylene moiety (unsymmetrical). Preferably, T is —(CH₂)ₓ-L-Q and the values of x, L and Q are the same on both side of the diacetylene moiety, such that the diacetylene compound of formula (I) is symmetrical.

For the present invention, if the colour-forming compound is selected to be a diacetylene, it may preferably have the following formula (II):

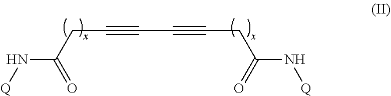

wherein x is from 2 to 12, preferably 2 to 10; and Q is selected from cyclopropyl and a —(CH₂)_{y}(CH₃) linear alkyl chain wherein y is selected from 1 to 20, preferably 5 to 19, and more preferably 5 to 17. Examples of suitable diacetylene compounds include, but are not limited to the following: N1,N22-dioctadecyldocosa-10,12-diynediamide, N1,N22-dihexadecyldocosa-10-12-N1,N22-diynediamide, N1,N22-ditetradecyldocoda-10,12-diynediamide, didodecyldocosa-10,12-diynediamide, N1,N22-didecyldocosa-10,12-diynediamide, N1,N22-dioctyldocosa-10,12-diynediamide, N1,N22-dihexyldocosa-10,12-diynediamide, N1,N22-dicyclopropyldocosa-10,12-diynediamide. If the colour-forming compound is selected to be a diacetylene, the diacetylene is more preferably selected from N1,N22-dioctadecyldocosa-10,12-diynediamide, N1,N22-dihexadecyldocosa-10,12-diynediamide, N1,N22-ditetradecyldocosa-10,12-diynediamide, N1,N22-didodecyldocosa-10,12-diynediamide, and N1,N22-dicyclopropyldocosa-10,12-diynediamide, and more preferably N1,N22-didodecyldocosa-10,12-diynediamide.

It is surprising and advantageous that a diacetylene can be utilised as a colour-forming compound in the present invention. It is surprising that the high-temperature processing conditions to form the plastic product having the leuco dye incorporated therein do not cause the leuco dye to either form colour or decompose. Furthermore, it is surprising that following production of the plastic product having the leuco dye incorporated therein, the leuco dye does not form colour under ambient lighting but only upon the specific application of radiation thereto, preferably by a laser source(s), lamp or LED.

The colour-forming compound may be a leuco dye. Leuco dyes are well known to a skilled person as compounds capable of forming colour. Examples of suitable leuco dyes are contained in WO 2015/015200 and WO 2013/068729, the content of which is incorporated herein by reference. Examples of suitable leuco dyes include, but are not limited to: spiroxazines, naphthopyrans, phthalides, fluorans, triarylmethanes, benzoxazines, quinazolines, spiropyrans, quinones, tetrazolium salts, thiazines, phenazines and oxazines, some of which are disclosed in WO2006/108745, the content of which is incorporated herein by reference.

Suitable suppliers of leuco dyes include, but are not limited to: Yamada Chemical Company Limited, Chameleon Speciality Chemicals Limited, and Connect Chemicals.

For the present invention, if the colour-forming compound is selected to be a leuco dye, the leuco dye may be selected from: 2-Anilino-3-diethylamino-6-methylfluoran, 2-Anilino-6-dibutylamino-3-methylfluoran, 6-(Dimethylamino)-3,3-bis[4-(dimethylamino)phenyl]phthalide, 4,4′-[(9-butyl-9H-carbazol-3-yl)methylene]bis[N-methyl-N-phenylaniline], 3,3′-Bis(1-n-octyl-2-methylindol-3-yl) phthalide, 6′-(Diethylamino)-3-oxo-spiro[isobenzofuran-1(3H), 9′-[9H]xanthene]-2′-carboxylic acid ethyl ester, 7-[4-(diethylamino)-2-ethoxyphenyl]-7-(2-methyl-1-octyl-1H-indol-3-yl) Furo[3,4-b]pyridin-5 (7H)-one, 2′-(Dibenzylamino)-6′-(diethylamino) fluoran, N,N-dimethyl-4-[2-[2-(octyloxy)phenyl]-6-phenyl-4-pyridinyl]-Benzenamine, and 6′-(diethylamino)-2′-[(dimethylphenyl)amino]-3′-methylspiro[isobenzofuran-1(3H), 9′-[9H]xanthene]-3-one, 2′-anilino-6′-[ethyl(p-tolyl)amino]-3′-methylspiro[isobenzofuran-1(3H), 9′-[9H]xanthene]-3-one (CAS No. 59129-79-2), 4,4′-[(9-butyl-9H-carbazol-3-yl)methylene]bis[N-methyl-N-phenylaniline] (CAS No. 67707-04-4), 6′-(diethylamino)-3-oxo-spiro[isobenzofuran-1(3H), 9′-(9H) xanthene]-2′carboxylic acid ethyl ester (CAS No. 154306-60-2), and 2′-(dibenxylamino)-6′-(diethylamino) fluoran (CAS No. 34372-72-0), 2′-Anilino-6′-(dibutylamino)-3′-methyl-3H-spiro[2-benzofuran-1,9′-xanthen]-3-one (CAS No. 89331-94-2), 6′-(Diethylamino)-3′-methyl-2′-(phenylamino)spiro[2-benzofuran-3,9′-xanthene]-1-one (CAS No. 29512-49-0), 2-Anilino-6′-[ethyl(p-toyl)amino]-3′-methylspiro[isobenzofuran-1(3H), 9′-[9H]xanthene]-3-one (CAS No. 59129-79-2), Blue3-CVL 6-(dimethylamino)-3,3-bis-[4-(dimethylamino)phenyl) phthalide (CAS No 1522-42-7), Blue-4 4,4′-[(9-butyl-9H-carbazol-3-yl)methylene]bis[N-methyl-N-phenylaniline] (CAS No 67707-04-4), Red-5 3,3′-Bis(1-n-octyl-2-methylindol-3-yl) phthalide (CAS No 50292-95-0), Orange-6 6′-(Diethylamino)-3-oxo-spiro[isobenzofuran-1(3H), 9′-[9H]xanthene]-2′-carboxylic acid ethyl ester (CAS No 154306-60-2), Blue-8 7-[4-(diethylamino)-2-ethoxyphenyl]-7-(2-methyl-1-octyl-1H-indol-3-yl) Furo[3,4-b]pyridin-5 (7H)-one (CAS No 87563-89-1), Green-9 2′-(Dibenzylamino)-6′-(diethylamino) fluoran (CAS No 34372-72-0), Yellow-10 N,N-dimethyl-4-[2-[2-(octyloxy)phenyl]-6-phenyl-4-pyridinyl]-Benzenamine (CAS No 144190-25-0), Black-15 6′-(diethylamino)-2′-[(dimethylphenyl)amino]-3′-methylspiro[isobenzofuran-1(3H), 9′-[9H]xanthene]-3-one (CAS No 36431-22-8), KetoAcid-1 4-(N,N-diethylamino)-2-hydroxy-2′-carboxybenzophenone (CAS No 5809-23-4), KetoAcid-2 4-(N,N-dibutylamino)-2-hydroxy-2′-carboxybenzophenone (CAS No 54574-82-2), 2-Anilino-3-diethylamino-6-methylfluoran, 2-Anilino-6-dibutylamino-3-methylfluoran, 6-(Dimethylamino)-3,3-bis[4-(dimethylamino)phenyl]phthalide, 4,4′-[(9-butyl-9H-carbazol-3-yl)methylene]bis[N-methyl-N-phenylaniline], 3,3′-Bis(1-n-octyl-2-methylindol-3-yl) phthalide, 6′-(Diethylamino)-3-oxo-spiro[isobenzofuran-1(3H), 9′-[9H]xanthene]-2′-carboxylic acid ethyl ester, 7-[4-(diethylamino)-2-ethoxyphenyl]-7-(2-methyl-1-octyl-1H-indol-3-yl) Furo[3,4-b]pyridin-5 (7H)-one, 2′-(Dibenzylamino)-6′-(diethylamino) fluoran, N, N-dimethyl-4-[2-[2-(octyloxy)phenyl]-6-phenyl-4-pyridinyl]-Benzenamine, and 6′-(diethylamino)-2′-[(dimethylphenyl)amino]-3′-methylspiro[isobenzofuran-1(3H), 9′-[9H]xanthene]-3-one, 4,4′-[(9-butyl-9H-carbazol-3-yl)methylene]bis[N-methyl-N-phenylaniline] (CAS No. 67707-04-4), 6′-(diethylamino)-3-oxo-spiro[isobenzofuran-1(3H), 9′-(9H) xanthene]-2′carboxylic acid ethyl ester (CAS No. 154306-60-2), and 2′-(dibenxylamino)-6′-(diethylamino) fluoran (CAS No. 34372-72-0).

For the present invention, if the colour-forming compound is selected to be a leuco dye, the leuco dye may preferably be selected from 6-(dimethylamino)-3,3-bis[4-(dimethylamino)phenyl]phthalide, 7-[4-(diethylamino)-2-ethoxyphenyl]-7-(2-methyl-1-octyl-1H-indol-3-yl) furo[3,4-b]pyridin-5 (7H)-one, 3,3′-bis(1-n-octyl-2-methylindol-3-yl) phthalide, N, N-dimethyl-4-[2-[2-(octyloxy)phenyl]-6-phenyl-4-pyridinyl]-benzenamine, 6′-(diethylamino)-2′-[(dimethylphenyl)amino]-3′-methylspiro[isobenzofuran-1(3H), 9′-[9H]xanthene]-3-one, 2′-anilino-6′-[ethyl(p-tolyl)amino]-3′-methylspiro[isobenzofuran-1(3H), 9′-[9H]xanthene]-3-one (CAS No. 59129-79-2), 4,4′-[(9-butyl-9H-carbazol-3-yl)methylene]bis[N-methyl-N-phenylaniline] (CAS No. 67707-04-4), 6′-(diethylamino)-3-oxo-spiro[isobenzofuran-1(3H), 9′-(9H) xanthene]-2′carboxylic acid ethyl ester (CAS No. 154306-60-2), 2′-Anilino-6′-(dibutylamino)-3′-methyl-3H-spiro[2-benzofuran-1,9′-xanthen]-3-one (CAS No. 89331-94-2), 6′-(Diethylamino)-3′-methyl-2′-(phenylamino)spiro[2-benzofuran-3,9′-xanthene]-1-one (CAS No. 29512-49-0) and 2′-(dibenxylamino)-6′-(diethylamino) fluoran (CAS No. 34372-72-0). More preferably, if the colour-forming compound is selected to be a leuco dye, the leuco dye is Blue3-CVL 6-(dimethylamino)-3,3-bis-[4-(dimethylamino)phenyl) phthalide (CAS No 1522-42-7).

When the colour-forming compound is a leuco dye, the plastic material or plastic product having the colour-forming compound incorporated therein further has an acid-generating agent also incorporated therein. Without being bound by theory, the present inventors consider that the acid-generating agent and the leuco dye interact to achieve colour formation. The acid-generating agent is present in the composition to facilitate a pH change through generation of acid upon application of the radiation. This acid generation facilitates the formation of colour by the leuco dye. By “acid” is meant any molecular entity or chemical species capable of donating a hydrogen (proton) or capable of forming a covalent bond with an electron pair. Suitable acid-generating agents include any suitable commercially available or chemically synthesisable acid-generating agents. Suitable acid-generating agents include but are not limited to ammonium sulphate. Preferably, the acid-generating agent is ammonium sulphate. It will be understood by a skilled person that the selection of the acid-generating agent is dependent upon the particular leuco dye utilised.

It is surprising and advantageous that a leuco dye can act as a colour-forming compound in the present invention. As noted above, colour formation occurs for a leuco dye through interaction with the acid-generating agent. Typically, when subjected to high-temperature conditions such as the high-temperature processing and manufacturing conditions utilised in the formation of the plastic products of the present invention, a leuco dye and known acid-generating agents would both enter the same phase (melt) and react to form colour. However, in the context of the present invention, premature colour formation by the leuco dye may be avoided through selection of a leuco dye and acid-generating agent having differing melt temperatures, and the processing temperature for the production of the plastic product (typically dependent upon the melt temperature of the plastic material) being selected to be lower than at least one of the melt temperatures of the leuco dye and acid-generating agent. Typically, a leuco dye may have a melting temperature of from 80 to 220° C., such as from 100 to 220° C., or even from 160 to 210° C. Typically, an acid-generating agent may have a melting temperature/decomposition temperature of from 100 to 270° C., such as from 110 to 250° C. Preferably, the avoidance of premature colour formation by the leuco dye is facilitated through the use of ammonium sulphate as a thermal acid-generating agent. Ammonium sulphate has a thermal decomposition/melt temperature of around 235° C. Accordingly, during high-temperature processing conditions, the ammonium sulphate has not melted/thermally decomposed such that the acid-generating agent is not in the same phase as the leuco dye. This occurs only upon the specific application of radiation such that the leuco dye forms colour and a mark or image is formed.

The plastic product or plastic material may comprise from 0.2 to 30 wt % of the acid-generating agent. By “wt %” here is meant the weight of the acid-generating agent with respect to the total weight of the acid-generating agent, colour-forming compound and plastic product or plastic material. This plastic product or plastic material includes any additive(s) incorporated in the plastic material/plastic material used to form the plastic product, and if present, any carrier or other component of a ‘liquid concentrate or masterbatch’, or any component of a solid masterbatch, used to introduce the particles of colour-forming compound into the plastic material/plastic material used to form the plastic product, as well as any NIR absorber if present.

As discussed below, the colour-forming compound, and if present, the acid-generating agent and/or NIR absorber (discussed below), may be introduced into a plastic material to form a plastic product of the present invention in a liquid concentrate or masterbatch or a solid masterbatch. In such instances, it will be appreciated that the plastic product formed of said plastic material may thus further comprise a carrier, or other additional components, used to form the liquid concentrate or masterbatch or solid masterbatch as discussed in more detail below. The use of liquid concentrate or masterbatch or solid masterbatch to introduce components, such as additives, into plastic materials is well known in the art, for example for colorants.

The colour-forming compound may be present in the plastic product of the present invention, in any suitable amount following production of the plastic products. It will be appreciated that this is the amount of colour-forming compound present in the plastic product of the present invention prior to application of radiation thereto. Similarly, the colour-forming compound may be used in the formation of the plastic product of the present invention in any amount. Preferably, the colour-forming compound is present in the plastic product in an amount of less than 15 wt. %, such as less than 12 wt. %, such as less than 10 wt. %, such as less than 5 wt % for example from 0.1 to 4 wt. %, such as less than 4 wt. % for example 0.1 to 3 wt. %, or less than 2 wt % for example from 0.1 to 1 wt. %. By “wt %” here is meant the weight of the colour-forming compound with respect to the total weight of the plastic product. This plastic product includes the colour-forming compound and the plastic material from which it is formed, including any additive(s) incorporated therein (discussed herein in more detail), and if present, any NIR absorber and/or acid-generating agent, or any carrier or other component of a ‘liquid concentrate or masterbatch’ or ‘solid masterbatch’ used to introduce the colour-forming compound into the plastic material (also discussed herein in more detail).

It is advantageous that less than 15 wt. %, such as less than 12 wt. %, such as less than 10 wt. %, such as less than 5 wt % for example from 0.1 to 4 wt. %, such as less than 4 wt. % for example 0.1 to 3 wt. %, or less than 2 wt % for example from 0.1 to 1 wt. % of colour-forming compound may be used in the formation of the plastic product of the present invention, and that the colour-forming compound may be present in the plastic product in an amount of less than 15 wt. %, such as less than 12 wt. %, such as less than 10 wt. %, such as less than 5 wt % for example from 0.1 to 4 wt. %, such as less than 4 wt. % for example 0.1 to 3 wt. %, or less than 2 wt % for example from 0.1 to 1 wt. % and that a distinct and discernible mark or image may be effectively formed. The incorporation of the colour-forming compound in such amounts for effective mark or image formation is advantageous, as the amounts are not considered to negatively affect the recyclability of the plastic products of the present invention, and their performance as packaging for a wide variety of dry and wet goods. In addition, it is considered that the amount will not negatively impact direct contact requirements, such as direct contact food standards, of the plastic products, such that they may conform to the required standards during storing, transporting and distributing a wide variety of consumable goods.

The amount of colour-forming compound present in the plastic product may be calculated by virtue of the amount of the colour-forming compound used in the formation of the plastic product. In other words, this may be the amount of the colour-forming compound in the plastic material having colour-forming compound incorporated therein that is used to form the plastic product.

The amount of colour-forming compound in the plastic product may therefore be quantified by virtue of the amount of colour-forming compound used in the formation of the plastic product. This may be the amount of colour-forming compound present in the plastic material (the plastic material having colour-forming compound incorporated therein) that is used to form the plastic product. The plastic material used to form the plastic product may therefore have less than 15 wt. %, such as less than 12 wt. %, such as less than 10 wt. %, such as less than 5 wt % for example from 0.1 to 4 wt. %, such as less than 4 wt. % for example 0.1 to 3 wt. %, or less than 2 wt % for example from 0.1 to 1 wt. %. In other words, the colour-forming compound may be present in the plastic material having the colour-forming compound incorporated therein, that is used to form the plastic product, in an amount of less than 15 wt. %, such as less than 12 wt. %, such as less than 10 wt. %, such as less than 5 wt % for example from 0.1 to 4 wt. %, such as less than 4 wt. % for example 0.1 to 3 wt. %, or less than 2 wt % for example from 0.1 to 1 wt. %. By “wt %” here is meant the weight of the colour-forming compound with respect to the total weight of the colour-forming compound and the plastic material. This plastic material includes any additive(s) incorporated therein, and if present, any carrier or other component of a ‘liquid concentrate or masterbatch’ or ‘solid masterbatch’, used to introduce the particles of colour-forming compound into the plastic material, as well as any NIR absorber and/or acid-generating agent.

Without being bound by theory, if the colour-forming compound is selected to be sodium molybdate dihydrate or ammonium pentaborate tetrahydrate or ammonium pentaborate octahydrate, the present inventors consider that the plastic products of the present invention may comprise a trace amount of sodium molybdate or ammonium pentaborate tetrahydrate or ammonium pentaborate octahydrate respectively in dehydrated form following production. This may be prior to the application of radiation using a laser source(s), lamp or LED. Dehydrated forms of sodium molybdate include sodium molybdate monohydrate (Na₂MoO₄·H₂O) and anhydrous sodium molybdate (Na₂MoO₄; CAS No. 7631-95-0). Dehydrated forms of ammonium pentaborate tetrahydrate include anhydrous ammonium pentaborate (CAS No. 12007-89-5) and diammonium decaboorate (ammonium borate). Dehydrated forms of ammonium pentaborate tetrahydrate include anhydrous ammonium pentaborate tetrahydrate, ammonium pentaborate (CAS No. 12007-89-5) and diammonium decaboorate (ammonium borate).

The present inventors consider that the colour-forming compound is preferably present in the plastic product in solid form, and more preferably in particulate form, i.e. as particles of colour-forming compound. Preferably, the plastic product of the present invention is formed of a plastic material having colour-forming compound incorporated therein, wherein the colour-forming compound is present in solid form. More preferably, the plastic product of the present invention is formed of a plastic material having particles of colour-forming compound incorporated therein. For example, this is the case when the colour-forming compound is an inorganic hydrate such as sodium molybdate dihydrate or ammonium pentaborate tetrahydrate or ammonium pentaborate octahydrate, kaolin such as calcined kaolin, potassium bicarbonate, a leuco dye, or oxyanion of a multivalent metal, or oxyacid, and/or hydrate thereof, preferably when the colour-forming compound is an inorganic hydrate such as sodium molybdate dihydrate or ammonium pentaborate tetrahydrate or ammonium pentaborate octahydrate, kaolin such as calcined kaolin, potassium bicarbonate, or a leuco dye.

The plastic product or plastic material used to form the plastic product of the present invention may further have an NIR absorber incorporated therein. Preferably, when used, the NIR absorber is present in the plastic material, and thus the plastic product, in solid form. The NIR absorber may be present in particulate form as particles of NIR absorber. The NIR absorber has been introduced into the plastic material during formation of the plastic product in solid form as particles of NIR absorber. Alternatively, when used, the NIR absorber and colour-forming compound, and if required, the acid-generating agent, may be present in particulate form as combination particles of NIR absorber and colour-forming compound, and if present, acid-generating agent. By ‘combination particles’ is meant that the NIR absorber and colour-forming compound, and if present the acid-generating agent, are integrated together in individual particles, rather than a particulate mixture of particles of the NIR absorber with particles of the colour-forming compound (and if required, particles of the acid-generating agent), being present in the plastic material or plastic product.

Preferably, the colour-forming compound, acid-generating agent and NIR absorber are present in the plastic material or plastic product as combination particles when the colour-forming compound is a leuco dye as detailed herein.

The NIR absorber may be any suitable compound that is capable of absorbing near-infrared or infrared radiation, preferably near-infrared radiation. More than one NIR absorber may be present. It will be appreciated that when present, the NIR absorber enhances the absorption by the plastic product of the near-infrared or infrared radiation, preferably near-infrared radiation, applied thereto. Suitable examples of NIR absorbers include, but are not limited to the following: inorganic copper salts, such as copper (II) hydroxyl phosphate; organic NIR dyes and pigments, such as N,N,N′,N′-tetrakis(4-dibutylaminophenyl)-p-benzoquinone bis(iminium hexafluoro-antimonate); non-stoichiometric, reduced or doped inorganic compounds such as reduced indium tin oxide, reduced zinc oxide, reduced tungsten oxide, reduced doped tungsten oxide including an inorganic compound of the following formula MxWyOz (where M is at least one element selected from the group consisting of H, He, alkali metal, alkaline earth metal, rare earth element, Mg, Zr, Cr, Mn, Fe, Ru, Co, Rh, Ir, Ni, Pd, Pt, Cu, Ag, Au, Zn, Cd, Al, Ga, In, TI, Si, Ge, Sn, Pb, Sb, B, F, P, S, Se, Br, Te, Ti, Nb, V, Mo, Ta, Re, Be, Hf, Os, Bi and I, W is tungsten, O is oxygen, satisfying 0.001≤x/y≤1; and 2.2≤z/y≤3.0), reduced antimony tin oxide, or doped metal oxides such as aluminium-doped zinc oxide (AZO) and fluorine-doped tin oxide (FTO); conductive polymers such as poly polystyrene sulfonate (PEDOT); and combinations thereof. The NIR absorber may be an inorganic copper salt such as copper (II) hydroxyl phosphate.

The NIR absorber may have any suitable D₅₀ particle size distribution value. D₅₀ particle size distribution is the mean diameter or mean value of the particle size distribution, i.e. the particle diameter at 50% in the cumulative distribution. Preferably, the D₅₀ particle size distribution value of the NIR absorber is 5 μm or less. More preferably, the D₅₀ particle size distribution value of the NIR absorber is from 0.5 to 3 μm, and most preferably from 1 to 2 μm. D₅₀ particle size distribution is measured using a Malvern Mastersizer according to ISO standard 13320:2009.

If an NIR absorber is present, it may be selected from inorganic copper salts such as copper (II) hydroxyl phosphate; and non-stoichiometric, reduced or doped inorganic compounds such as reduced indium tin oxide, reduced zinc oxide, reduced tungsten oxide, reduced doped tungsten oxide including an inorganic compound of the following formula MxWyOz (where M is at least one element selected from the group consisting of H, He, alkali metal, alkaline earth metal, rare earth element, Mg, Zr, Cr, Mn, Fe, Ru, Co, Rh, Ir, Ni, Pd, Pt, Cu, Ag, Au, Zn, Cd, Al, Ga, In, TI, Si, Ge, Sn, Pb, Sb, B, F, P, S, Se, Br, Te, Ti, Nb, V, Mo, Ta, Re, Be, Hf, Os, Bi, I, and ammonium, Wis tungsten, O is oxygen, satisfying 0.001≤x/y≤ 1; and 2.2≤z/y≤3.0), reduced antimony tin oxide, or doped metal oxides such as aluminium-doped zinc oxide (AZO) and fluorine-doped tin oxide (FTO).

The plastic product or plastic material may comprise from 0.01 to 20 wt. % of NIR absorber, such as from 0.01 to 15 wt. %, or from 0.01 to 10 wt. %, or from 0.01 to wt. %, such as from 0.01 to 3 wt. % NIR absorber. By “wt %” here is meant the weight of the NIR absorber with respect to the total weight of the NIR absorber, colour-forming compound and plastic product or plastic material. This plastic product or plastic material includes any additive(s) incorporated in the plastic material/plastic material used to form the plastic product, and if present, any carrier or other component of a ‘liquid concentrate or masterbatch’ or ‘solid masterbatch’, used to introduce the particles of colour-forming compound into the plastic material/plastic material used to form the plastic product, as well as any acid-generating agent if present.

The plastic product of the present invention may be transparent, translucent or opaque. It will be appreciated that this is other than where the mark or image is formed. The plastic products may have haze and/or cloudiness. This may be inherent from the plastic material utilised in the formation of the plastic product. Preferably, the plastic products of the present invention have low haze and/or low cloudiness Where the plastic material used to form the plastic product, and thus the plastic product, is not transparent, then the plastic product can be translucent or opaque. It will be appreciated that any haze and/or cloudiness may result from the type of plastic material used to form the plastic product of the present invention.

The plastic product of the present invention may be coloured or be colourless. It will be appreciated that, if coloured, this is the ‘background’ colour of the plastic product, i.e. the colour of the plastic product itself not the colour of the mark or image. To provide a coloured plastic product, i.e. a plastic product having a ‘background’ colour, any suitable method may be used. For example, the plastic material used to form the plastic product may have an inherent colour, or shade thereof, and this is displayed by the resulting plastic product. Alternatively, if, for example, an NIR absorber is present in the plastic material and thus plastic product, the colour of the NIR absorber may be displayed by the plastic product.

In addition, as discussed below, ‘background’ colour may be introduced to the plastic product during formulation of the plastic product using a coloured masterbatch or coloured components to form the solid masterbatch or liquid concentrate or masterbatch. Still further, as exemplified herein, prior to the application of radiation to the plastic product to form the mark or image, the interior of the plastic product may be dyed to give the plastic product a ‘coloured’ background.

By ‘colour’ as used herein in relation to both the colour-forming compound and the ‘background’ colour of the plastic product, includes all colours, tints, shades and hues of the visible light colour spectrum, i.e. red, orange, yellow, blue, green and violet, in addition to colours, tints, shades and hues of black, brown, white, turquoise, purple, pink, cyan, magenta, and all mixtures thereof. All primary, secondary, tertiary, quaternary and quinary colours are encompassed. In the context of the present invention, the term may also be used to describe differing shades of each of the colours of the visible light colour spectrum, in addition to black, brown, white for example off-white, turquoise, purple, pink, cyan, and magenta. Further, in the context of the present invention, where the plastic product is a multi-layer plastic product, it may be advantageous for an additional layer, such as a barrier layer, to be coloured.

In order for the mark or image to be discernible and distinct relative to the plastic product, the plastic product may be colourless, have a ‘background’ colour different to that of the mark or image formed, or a have a ‘background’ colour the same colour as the mark or image but of less opacity, such that a contrasting distinct and discernible image is formed.

In order that colour-forming compound is incorporated within the plastic product, the colour-forming compound is introduced into the plastic material used to form the plastic product prior to production of the plastic product. This is also the case for any NIR absorber and/or acid-generating agent, if present.

According to a second aspect of the present invention, there is provided a plastic product formed of a plastic material having a colour-forming compound incorporated therein, the plastic product having been produced by bringing the colour forming compound into contact with a plastic material to form a plastic material having the colour forming compound incorporated therein, and forming the plastic material having the colour forming compound incorporated therein into the plastic product, wherein the plastic product is a plastic preform or plastic packaging.

According to a third aspect of the present invention, there is provided a plastic product formed of a plastic material having a colour-forming compound incorporated therein, the plastic product having been produced by forming a plastic material having the colour-forming compound incorporated therein into a plastic product, wherein the plastic product is a plastic preform or plastic packaging.

According to a fourth aspect of the present invention, there is provided a method of producing a plastic product formed of a plastic material having a colour-forming compound incorporated therein, the method comprising bringing the colour-forming compound into contact with a plastic material to form a plastic material having the colour-forming compound incorporated therein, and forming the plastic material having particles of the colour-forming compound incorporated therein into the plastic product.

According to a fifth aspect of the present invention, there is provided a method of producing a plastic product formed of a plastic material having a colour-forming compound incorporated therein, the method comprising forming a plastic material having the colour-forming compound incorporated therein into a plastic product.

According to a sixth aspect of the present invention, there is provided a use of a colour-forming compound in the production of a plastic material having the colour-forming compound incorporated therein, or in the production of a plastic product having the colour-forming compound incorporated therein.

According to a seventh aspect of the present invention, there is provided a mixture comprising:
(i) a colour-forming compound; and
(ii) a plastic material.

All features of the second to seventh aspects of the present invention detailed above, including all preferred and optional features as detailed below, are applicable to all other aspects described herein. In the same manner, all features of all other aspects described herein, including preferred and optional features of each aspect, are applicable to the second to seventh aspects of the present invention detailed above.

The colour-forming compound used in the production of the plastic products according to the present invention may be in particle form. They may have any particle size suitable for incorporation into the plastic material used to form the plastic products.

The colour-forming compound utilised in the second to seventh aspects of the present invention may be present as particles of colour-forming compound, in powder form.

The particles of colour-forming compound may have a volume-weighted mean diameter D[4,3] of from 0.1 to 40 μm, such as from 0.5 to 20 μm. Preferably, the particles of colour-forming compound have a volume-weighted mean diameter D[4,3] of from 1 to 15 μm, such as from 1 to 10 μm, or from 1 to 7 μm. Most preferably, the particles of colour-forming compound have a volume-weighted mean diameter D[4,3] of from 3 to 7 μm.

Such a volume-weighted mean diameter D[4,3] enables the colour-forming compound to be incorporated homogeneously in the final plastic product. This facilitates efficient formation of a mark or image on the plastic products of the present invention.

Particles of the colour-forming compound having such a volume-weighted mean diameter D[4,3] may be produced by any suitable method. If required, the colour-forming compound can be dry ground or milled to from a fine powder of particles of colour-forming compound having the volume mean diameter D[4,3] detailed above. Suitable apparatus for such grinding or milling will be well known to a skilled person, and includes ‘opposed jet mill’ equipment as used by, for example, British Rema.

Methods of measuring the volume-weighted mean diameter D[4,3] will be well known to a skilled person, and include measurements using a Malvern Mastersizer™ particle size analyser from Malvern Instruments under ISO standard ISO 13320:2020.

The particles of colour-forming compound may have a surface-weighted mean diameter D[3,2] of from 0.5 to 4.0 μm, preferably from 1.0 to 4.0 μm, or more preferably from 1.6 to 4.0 μm.

Methods of measuring the surface-weighted mean diameter D[3,2] will be well known to a skilled person, and include measurements using a Malvern Mastersizer™ particle size analyser from Malvern Instruments under ISO standard ISO 13320:2020.

Without being bound by theory, the present inventors expect that when the colour-forming compound is present in the plastic products of the present invention in solid form, preferably in particulate form, i.e. as particles of colour-forming compound, the particles of the colour-forming compound present in the plastic product may also have the volume-weighted mean diameter D[4,3], surface area and/or surface-weighted mean diameter D[3,2] discussed above. This is the case if no additional grinding or milling takes places during production of the plastic products using particles of the colour-forming compound having the above volume-weighted mean diameter D[4,3], surface area and/or surface-weighted mean diameter D[3,2].

The plastic materials which may be utilised for the production of the plastic products are as described above in relation to the first aspect of the present invention. It will be appreciated that, as discussed above, the plastic material may further comprise additives. These additives may be already part of a plastic material to be utilised in the production of the plastic products (e.g. incorporated in the plastic material, for example, incorporated in plastic pellets), or introduced into a plastic material during the production of the plastic products.

In the formation of the plastic products of the present invention, the colour-forming compound, and if present, NIR absorber and/or acid-generating agent, is brought into contact with a plastic material. The colour-forming compound, and if present, NIR absorber and/or acid-generating agent, is thus introduced into the plastic material. A plastic material having the colour-forming compound, and if present, NIR absorber and/or acid-generating agent, incorporated therein is produced. The colour-forming compound is preferably in the form of particles of colour-forming compound. This is also the case for the NIR absorber and/or acid-generating agent, if utilised. The plastic material may be molten when the colour-forming compound, and if present, NIR absorber and/or acid-generating agent, is brought into contact therewith. Preferably, the plastic material is molten when the colour-forming compound, and if present, NIR absorber and/or acid-generating agent, is brought into contact therewith.

By the term “molten” in reference to the plastic material, is meant that the plastic material is able to flow. To become molten, the plastic material is heated at or above its melting (melt) temperature such that it can be processed and manufactured into the plastic product. Typically, the plastic material is heated to a temperature in the range of 50 to 350° C., such as 100 to 300° C.—processing temperature. It will be appreciated that this temperature will vary depending upon the plastic material being used and the melting temperature thereof, as well as the type of plastic product being formed. For example, the melting temperature of PET is 260° C., whereas HDPE is around 130° C.

Preferably, prior to utilisation in the processes described herein to form the plastic products of the present invention, the plastic material may be in any form, such as in the form of powder, pellets, prills or granules. Molten plastic material may be obtained through the heating of the plastic powder, pellets, prills or granules.

The colour-forming compound, and if present, NIR absorber and/or acid-generating agent, may be brought into contact with the plastic material in a number of different ways. For example, particles of the colour-forming compound, and if present, NIR absorber and/or acid-generating agent (as a dry powder), or combination particles of the colour-forming compound and NIR absorber, and if present acid-generating agent (as a dry powder), may be brought into contact and combined with a plastic material (preferably in the form of plastic powder, pellets, prills or granules) and then the mixture heated such that the plastic material becomes molten and a plastic material having the colour-forming compound, and if present, NIR absorber and/or acid-generating agent, incorporated therein is formed. Alternatively, the particles of the colour-forming compound, and if present, NIR absorber and/or acid-generating agent (as a dry powder), or combination particles of the colour-forming compound and NIR absorber, and if present acid-generating agent (as a dry powder), may be brought into contact and combined with a molten plastic material. Preferably, the particles of colour-forming compound, and if present, NIR absorber and/or acid-generating agent, or combination particles of colour-forming compound and NIR absorber, and acid-generating agent if present, may be brought into contact and combined with a molten plastic material. In each case, the resulting combination of molten plastic material having the colour-forming compound, and if present, NIR absorber and/or acid-generating agent, incorporated therethrough may be optionally cooled and granulated or pelletised to form a ‘solid masterbatch’. This may be done using a twin screw extruder compounding apparatus. The ‘solid masterbatch’ may then be heated to become molten and used to form the plastic product, or optionally brought into contact with further plastic material and then heated such that it all becomes molten and used to form the plastic product. It will be appreciated that the plastic material used to form the ‘solid masterbatch’ may be the same or different to that used to form the plastic product. Typically, the plastic material used to form the ‘solid masterbatch’ may be different to that used to form the plastic product when the plastic product is to be a PET plastic product. Where the plastic material used to form the ‘solid masterbatch’ is different to that used to form the plastic product, it will be clear to a skilled person that the plastic material will be a plastic material compatible with the plastic material to be used to form the product. For example, for a PET product, the plastic material used to form the solid masterbatch may be PET-G, or based thereon, PET-G being a plastic material compatible with PET. By ‘compatible’ as used herein in relation to the solid masterbatch is meant that the plastic material of the solid masterbatch will fully integrate with, or form part of the polymer matrix of, the plastic material used to form the plastic product.

It will also be appreciated that the solid masterbatch may optionally comprise other additional components. Other additional components of the solid masterbatch may include one or more additives such plasticisers and/or flow additives. The solid masterbatch may also be coloured through use of a colour masterbatch in the formulation of the solid masterbatch to provide colour thereto. The colour masterbatch used will be compatible with the plastic material used to form the plastic product. It will be appreciated that any additional components will be compatible with the plastic material used to form the plastic product.

Alternatively, particles of colour-forming compound, and if present, NIR absorber and/or acid-generating agent (as a dry powder), or combination particles of colour-forming compound and NIR absorber, and if present acid-generating agent (as a dry powder), may be incorporated into a ‘liquid concentrate or masterbatch’ that is then brought into contact with, preferably injected into, molten plastic material. Preferably, the particles of colour-forming compound, and if present, NIR absorber and/or acid-generating agent, or combination particles of colour-forming compound and NIR absorber, and if present acid-generating agent, are incorporated into a ‘liquid concentrate or masterbatch’ that is then brought into contact with, preferably injected into, molten plastic material. By ‘liquid concentrate or masterbatch’ is meant a liquid composition comprising particles of colour-forming compound, and if present, NIR absorber and/or acid-generating agent suspended in a carrier. Typically, the particles of colour-forming compound, and if present, NIR absorber and/or acid-generating agent (as a dry powder), or combination particles of the colour-forming compound and NIR absorber, and acid-generating agent if present, are mixed into the carrier, at room temperature. Typically, the carrier is oleophilic. Typically, the carrier is water insoluble, and therefore hydrophobic. The carrier may be a non-aqueous carrier, an oil-based carrier including a bio-derived oil-based carrier, mineral oil-based carriers or a petroleum-based carrier. The carrier may comprise petroleum hydrocarbons, mineral oil, an organic solvent-based medium, a liquid polymer such as polybutene, liquid monomer such as a liquid acrylic monomer, liquid oligomer, or a mixture or combination of hydrocarbons. The carrier, and thus the liquid composition, is compatible with the plastic material used to form the plastic product. By ‘compatible’ as used herein in relation to the liquid masterbatch is meant that the liquid masterbatch will fully integrate with, or form part of the polymer matrix of, the plastic material used to form the plastic product. It will be appreciated that the liquid composition may optionally comprise other additional components. Other additional components of the liquid composition may include one or more additives such as thermal stabilisers, antioxidants, surfactants and/or dispersing agents. Colour components may also be included to facilitate ‘background’ colour. The ‘liquid concentrate or masterbatch’ may be a commercially available product. Such products will be well known to a skilled person. It will be appreciated that, in some instances, further milling or grinding of the particles of colour-forming compound, and if present, NIR absorber and/or acid-generating agent, may occur during formation of the ‘liquid concentrate or masterbatch’.

The use of a ‘solid masterbatch’ or a ‘liquid concentrate or masterbatch’ in the formation of plastic materials and plastic products is known in the art. It is known to utilise such masterbatches, for example, to overcome manufacturing problems experienced when introducing additives to polymers or copolymers using in the formation of plastic materials and plastic products. A typical method for overcoming these problems involves the use of a concentrate of the additive(s) required in a carrier, see for example, Plastics Additives Handbook (Hans Zweifel, Hanser, Munich, 6. Edition, 2009).

Where a ‘solid masterbatch’ or a ‘liquid concentrate or masterbatch’ is utilised, the masterbatch may comprise 5 to 90 wt. % colour-forming compound, such as from 9 to 90 wt %, such as from 25 to 90 wt %, such as from 25 to 80 wt %, or from 50 to 75% such as 40 to 70 wt %. By wt % is the weight of the colour-forming compound with respect to the weight of the total ‘solid masterbatch’ or ‘liquid concentrate or masterbatch’, i.e. the weight of the colour-forming compound with respect to the total weight of the colour-forming compound, the NIR absorber and/or acid-generating agent if present, the carrier, and any other components, of the ‘liquid concentrate or masterbatch’, or the weight of the colour-forming compound with respect to the total weight of the colour-forming compound, the NIR absorber and/or acid-generating agent if present, and the plastic material of the ‘solid masterbatch’, including any other components if present.

Where a ‘solid masterbatch’ or a ‘liquid concentrate or masterbatch’ is utilised, the masterbatch may comprise from 0.4 to 20 wt %, such as from 0.5 to 10 wt. % NIR absorber. By wt % is the weight of the NIR absorber with respect to the weight of the total ‘solid masterbatch’ or ‘liquid concentrate or masterbatch’, i.e. the weight of the NIR absorber with respect to the total weight of the colour-forming compound, the NIR absorber and acid-generating agent, if present, the carrier, and any other components, of the ‘liquid concentrate or masterbatch’, or the weight of the colour-forming compound with respect to the total weight of the colour-forming compound, the NIR absorber and, if present, the acid-generating agent, and the plastic material of the ‘solid masterbatch’, including any other components if present.

Where a ‘solid masterbatch’ or a ‘liquid concentrate or masterbatch’ is utilised, the masterbatch may comprise from 2 wt % to 90 wt % acid-generating agent, preferably 2 to 60 wt %, such as 2 to 55 wt % acid-generating agent. By wt % is the weight of the NIR absorber with respect to the weight of the total ‘solid masterbatch’ or ‘liquid concentrate or masterbatch’, i.e. the weight of the NIR absorber with respect to the total weight of the colour-forming compound, the NIR absorber and acid-generating agent, if present, the carrier, and any other components, of the ‘liquid concentrate or masterbatch’, or the weight of the sodium the colour-forming compound with respect to the total weight of the colour-forming compound, the NIR absorber and, if present, the acid-generating agent, and the plastic material of the ‘solid masterbatch’, including any other components if present.

It will be appreciated that the use of a ‘solid masterbatch’ or a ‘liquid concentrate or masterbatch’ to introduce components, such as additives, into plastic materials is well known in the art.

Where a ‘solid masterbatch’ or a ‘liquid concentrate or masterbatch’ is utilised, the masterbatch comprising the colour-forming compound may be used in an amount of less than 20 wt %, such as less than 12 wt %, or less than 6 wt. %, such as less than 4 wt. %, or less than 2 wt. % relative to the plastic material. By “wt %” is the weight of the masterbatch with respect to the total weight of the masterbatch (which includes, if present, any carrier or other component, or the NIR absorber and/or acid-generating agent if present) and the plastic material. This plastic material includes any additive(s) incorporated therein. Accordingly, the plastic material may be used in an amount of from 80 wt % or more, such as from 88 wt % or more.

The colour-forming compound is brought into contact, and introduced into, the plastic material, i.e. the colour-forming compound is used in the processes according to the second to sixth aspect of the present invention, in an amount of preferably less than 15 wt. %, such as less than 12 wt. %, such as less than 10 wt. %, such as less than 5 wt % for example from 0.1 to 4 wt. %, such as less than 4 wt. % for example 0.1 to 3 wt. %, or less than 2 wt % for example from 0.1 to 1 wt. %. By “wt %” is the weight of the colour-forming compound with respect to the total weight of the colour-forming compound, and if present, NIR absorber and/or acid-generating agent, and plastic material. This plastic material includes any additive(s) incorporated therein, and if present, any carrier or other component of a ‘liquid concentrate or masterbatch’, or any component of a ‘solid masterbatch’, used to introduce the colour-forming compound, and if present, NIR absorber and/or acid-generating agent, into the plastic material.

In the context of the seventh aspect of the present invention, it will be appreciated that the plastic material is preferably molten. It will be appreciated therefore that the colour-forming compound, and if present, NIR absorber and/or acid-generating agent, may be incorporated within the plastic material when the plastic material is molten. The colour-forming compound may be present as particles of colour-forming compound. Preferably, the colour-forming compound is present as particles of colour-forming compound. It will also be appreciated that the colour-forming compound and if present, NIR absorber and/or acid-generating agent, may be present in the mixture as part of a ‘liquid concentrate or masterbatch’ or ‘solid masterbatch’ as discussed herein. Alternatively, it will be appreciated that for the mixture of the seventh aspect of the present invention, the colour-forming compound may be present as particles of colour-forming compound such as a dry powder, and the plastic material present as powder, pellets, granules or prills.

The colour-forming compound are preferably present in the mixture according to the seventh aspect of the present invention in an amount of from less than 15 wt. %, such as less than 12 wt. %, such as less than 10 wt. %, such as less than 5 wt % for example from 0.1 to 4 wt. %, such as less than 4 wt. % for example 0.1 to 3 wt. %, or less than 2 wt % for example from 0.1 to 1 wt. %. By “wt %” is the weight of the colour-forming compound with respect to the total weight of the mixture, i.e. the colouring forming compound, and if present, NIR absorber and/or acid-generating agent, and plastic material. This plastic material includes any additive(s) incorporated therein, and if present, any carrier or other component of a ‘liquid concentrate or masterbatch’, or any component of a ‘solid masterbatch’, used to introduce the colour-forming compound, and if present, NIR absorber and/or acid-generating agent, into the plastic material. Preferably, the plastic material of the seventh aspect of the present invention is molten. Preferably, the plastic material of the seventh aspect of the present invention is molten and the colour-forming compound is particles of colour-forming compound.

The present invention thus further relates to a plastic material, preferably a molten plastic material, having a colour-forming compound incorporated therein.

The present invention also further relates to a method of forming a plastic material having a colour-forming compound incorporated therein, the method comprising bringing the colour-forming compound into contact with a plastic material.

All features of these further aspects of the present invention, including all preferred and optional features as detailed below, are applicable to all other aspects described herein. In the same manner, all features of all other aspects described herein, including preferred and optional features of each aspect, are applicable to these further aspects of the present invention.

Typically, the colour-forming compound may be present in the plastic material in an amount of less than 15 wt. %, such as less than 12 wt. %, such as less than 10 wt. %, such as less than 5 wt % for example from 0.1 to 4 wt. %, such as less than 4 wt. % for example 0.1 to 3 wt. %, or less than 2 wt % for example from 0.1 to 1 wt. %. By “wt %” here is meant the weight of the colour-forming compound with respect to the total weight of the colour-forming compound, and if present, NIR absorber and/or acid-generating agent, and the plastic material. This plastic material includes any additive(s) incorporated therein, and if present, any carrier or other component of a ‘liquid concentrate or masterbatch’, or any component of a solid masterbatch, used to introduce the colour-forming compound, and if present, NIR absorber and/or acid-generating agent, into the plastic material.

Once the colour-forming compound, and if present, NIR absorber and/or acid-generating agent, has been brought into contact with the plastic material, and incorporated therein, the plastic products of the present invention are formed.

It will be appreciated that the colour-forming compound, and if present, NIR absorber and/or acid-generating agent, may be brought into contact with the plastic material, and incorporated therein, in the same process as required for formation of the plastic products of the present invention. This may be in the same apparatus or machinery. For example, when the plastic product is formed by injection molding, the colour-forming compound, and if present, NIR absorber and/or acid-generating agent, may be bought into contact with the plastic material, and incorporated therein, in an initial step in the apparatus or machinery, e.g. melt blended, before being injected into the molds. Alternatively, the colour-forming compound, and if present, NIR absorber and/or acid-generating agent, may be brought into contact with the plastic material prior to processing for formation of the plastic products of the present invention.

It will further be appreciated that the plastic material itself may be formulated in the same apparatus or machinery in which the formation of the plastic products of the present invention takes place. Such methods are well known in the art. For example, the plastic material may be formulated through the addition of additives in an initial step. This may be prior to, during, or following, contact with the colour-forming compound, and if present, NIR absorber and/or acid-generating agent. The additives may be introduced as solids, solids dissolved in liquids or as liquids, including in a liquid or solid concentrate or masterbatch. Alternatively, additives may have been introduced into the plastic material prior to its addition to the apparatus or machinery in which the formation of the plastic products of the present invention takes place. Such methods are well known in the art.

Typically, the plastic material having the colour-forming compound incorporated therein is formed into a plastic product by thermal processing. These processes for forming the plastic products of the present invention typically include high-temperature processing conditions. Typical conditions for thermal processing include temperatures in the region of 50 to 350° C., such as 100 to 300° C. and pressures of from 1000 kPa to 4000 kPa. It will be appreciated that, as discussed above, the particular temperature used during processing depends upon the plastic material being utilised and its melting (melt) temperature, as well as the type of plastic product being formed.

Suitable processes for forming the plastic products of the present invention will be well known to a skilled person. These include thermal processing methods such as extrusion molding, extrusion blow molding, 3D printing, compression molding, rotational molding, thermoforming, injection molding, and blow molding, or combinations thereof. Suitable equipment for these thermal processing methods will be well known to a person skilled in the art.

When the plastic product being produced is a plastic preform, the plastic preform is typically produced by injection molding. Typical conditions for injection molding include a temperature of from 200 to 300° C. Suitable equipment for achieving such injection molding includes injection molding systems from Aaburg.

When the plastic product being produced is a plastic bottle, as well as the use of known techniques such as blow molding to produce a plastic bottle, another way in which a plastic bottle may be produced is by injection molding to form a plastic preform, followed by blow molding the plastic preform to form a plastic bottle. Typical conditions injection molding and suitable equipment are as described above. Typical conditions for blow molding include a temperature of from 100 to 200° C., such as from 100 to 150° C., and pressures of from 1000 to 4000 kPa. Suitable equipment for achieving such blow molding includes blow molding machines available from Parker Plastic Machinery.

It will be appreciated that in the production of a plastic bottle via a plastic preform, the production of the plastic preform and subsequent plastic bottle may take place on the same machinery or equipment, typically in a continuous process, or each stage (formation of plastic preform, and subsequent formation of plastic bottle from plastic preform) may take place separately, typically on separate machines. Suitable equipment for achieving the 1 or 2 step process includes machines available from Parker Plastic Machinery.

Therefore, according to a further aspect of the present invention, there is provided a method of producing a plastic preform, and optionally a plastic bottle, the plastic preform or plastic bottle being formed of a plastic material having a colour-forming compound incorporated therein, the method comprising bringing the colour-forming compound into contact with a plastic material to form a plastic material having the colour-forming compound incorporated therein, and forming a plastic preform from the plastic material having the colour-forming compound incorporated therein, and optionally forming the plastic preform into a plastic bottle. Preferably, a plastic bottle is formed.

According to a further aspect of the present invention, there is provided a method of producing a plastic preform, and optionally a plastic bottle, the plastic preform or plastic bottle being formed of a plastic material having a colour-forming compound incorporated therein, the method comprising forming a plastic preform from the plastic material having the colour-forming compound incorporated therein, and optionally forming the plastic preform into a plastic bottle. Preferably, a plastic bottle is formed.

All features of these further aspects of the present invention detailed above, including all preferred and optional features as detailed below, are applicable to all other aspects described herein. In the same manner, all features of all other aspects described herein, including preferred and optional features of each aspect, are applicable to these further aspects of the present invention detailed above.

For the present invention, it is surprising and advantageous that distinct and discernible marks or images can be formed on the plastic products following the exposure of the colour-forming compounds to the high-temperature processing and manufacturing conditions required during formation of the plastic products. It is surprising that, upon exposure to the high-temperature processing and manufacturing conditions, the colour-forming compounds do not form colour to a so as to prevent the subsequent formation or a mark(s) or image(s) upon the specific application of radiation to the plastic product.

The incorporation of a colour-forming compound into the plastic products of the present invention facilitates the display of a mark(s) or image(s) by the plastic products.

Therefore, according to an eighth aspect of the present invention, there is provided a plastic product displaying a mark or image, wherein the plastic product is formed of a plastic material having a colour-forming compound incorporated therein, wherein the plastic product is a plastic preform or plastic packaging.

According to a ninth aspect of the present invention, there is provided a plastic product displaying a mark or image, said product obtainable by applying radiation to a plastic product having a colour-forming compound incorporated therein such that the mark or image is formed where the radiation is applied to the plastic product, wherein the plastic product is a plastic preform or plastic packaging.

According to a tenth aspect of the present invention, there is provided a method of forming a mark or image on a plastic product, the method comprising exposing a plastic product to radiation to form the mark or image where the radiation is applied, wherein the plastic product is formed of a material having a colour-forming compound incorporated therein, and wherein the plastic product is a plastic preform or plastic packaging.

According to a further aspect of the present invention, there is provided a use of a colour-forming compound in the formation of a mark or image on a plastic product formed of a plastic material having a colour-forming compound incorporated therein.

All features of the eighth to tenth and further aspects of the present invention detailed above, including all preferred and optional features as detailed below, are applicable to all other aspects described herein. In the same manner, all features of all other aspects described herein, including preferred and optional features of each aspect, are applicable to the eighth to tenth and further aspects of the present invention detailed above.

It will be appreciated that the plastic product according to the first, second and third aspects of the present invention may be utilised to form the plastic product displaying an image according to the eighth and ninth aspects of the present invention.

The mark or image formed upon application of radiation to the plastic products of the present invention is clearly visible to the human eye and/or machine-readable.

It will be appreciated that in the context of the present invention, the mark or image is formed both on the surface of the plastic product and incorporated therein by virtue of the colour-forming compound being incorporated within the plastic product.

The mark(s) or image(s) formed upon application of radiation to the plastic products of the present invention is particularly distinct, discernible and clearly visible to the human eye.

The radiation may be applied to the plastic product to selectively facilitate colour formation at localised positions in order to form the desired image, i.e. the formation of variable information. The application of the radiation is controlled and specific. A human and/or machine-readable image is formed. This is typically only in a portion or region of the plastic product.

As discussed above, it will be appreciated that in the context of the present invention, the colour of the mark or image formed upon application of radiation will be contrasting to the part(s) of the plastic products to which radiation has not been applied.

The term “mark or image” as used herein incorporates, but is not limited to: logos, marks such as text and words, graphics, figures, pictures, symbols, codes such as linear barcodes, 2D Datamatrix, QR codes, Digimarc codes and text, such as that based on alphanumerics and symbols. It will be appreciated that in the context of the present invention, it is the manipulation of the colour-forming compound that facilitates the formation of a mark or image on and within the plastic product. The image formed will be human and/or machine readable, and can be used for coding and marking, tagging, tracking and tracing and late-stage customisation or personalisation purposes. The mark or image formed is typically a mark or image used to display variable information.

In the context of the present invention, the radiation is applied to the plastic product following formation thereof. This can occur immediately after formation (once the plastic product has cooled to ambient temperature), or at a later time, such as after storage or transportation. The radiation may be applied to the plastic product either when the plastic product is empty or alternatively filled or partially filled with contents.

“Radiation” and like terms used herein refers to energy in the form of waves or particles, and in particular, refers to electromagnetic radiation such as ultraviolet (UV), visible, near-infrared (NIR) and infrared (IR) particle radiation, e.g. alpha (a) radiation, beta (B) radiation, neutron radiation and plasma. The wavelength ranges of the different regions of the electromagnetic spectrum are known to a skilled person.

The radiation may be selected from ultraviolet (UV) radiation with a wavelength of from 10 to 400 nm, visible radiation with a wavelength of from 400 to 700 nm, infrared (IR) radiation with a wavelength of from 700 nm to 1 mm, including near-infrared (NIR) radiation with a wavelength of from 700 to 1600 nm. Preferably, the radiation is selected from UV radiation with a wavelength of 10 to 400 nm, IR radiation with a wavelength of from 700 nm to 1 mm, including near-infrared (NIR) radiation with a wavelength of from 700 to 1600 nm. More preferably, the radiation is selected from UV radiation with a wavelength of 250 to 370 or 405 nm, infrared (IR) radiation with a wavelength of 9300, 9600, 10200 or 10600 nm (applied using a CO₂ laser), infrared radiation with a wavelength of from 700 nm to 1 mm, and near-infrared (NIR) radiation with a wavelength of 700 to 1600 nm. More preferably, the radiation is selected from infrared (IR) radiation with a wavelength of 9300, 9600, 10200 or 10600 nm (applied using a CO₂ laser), infrared radiation with a wavelength of from 700 nm to 1 mm, and near-infrared (NIR) radiation with a wavelength of 700 to 1600 nm such as from 950 to 1100 nm. More preferably, the radiation is infrared (IR) radiation with a wavelength of 10600 nm (applied using a CO₂ laser) and near-infrared (NIR) radiation with a wavelength of from 700 to 1600 such as from 950 to 1100 nm.

It will be appreciated by a skilled person that the radiation selected will be that required to cause the colour-forming compound to form a distinct and discernible image.

When the colour-forming compound is sodium molybdate dihydrate, ammonium pentaborate tetrahydrate, ammonium pentaborate octahydrate, or potassium bicarbonate, the radiation is preferably infrared (IR) radiation with a wavelength of from 700 nm to 1 mm, such as infrared (IR) radiation with a wavelength of 9300, 9600, 10200 or 10600 nm (applied using a CO₂ laser).

When the colour-forming compound is kaolin such as calcined kaolin, the radiation is preferably selected from UV radiation with a wavelength of 10 to 400 nm such as from 250 to 370 or 405 nm, infrared (IR) radiation with a wavelength of from 700 nm to 1 mm, including near-infrared (NIR) radiation with a wavelength of from 700 to 1600 nm, preferably infrared (IR) radiation with a wavelength of from 700 nm to 1 mm, including near-infrared (NIR) radiation with a wavelength of from 700 to 1600 nm, such as infrared (IR) radiation with a wavelength of 9300, 9600, 10200 or 10600 nm (applied using a CO₂ laser) and near-infrared (NIR) radiation with a wavelength of 700 to 1600 nm, and more preferably infrared (IR) radiation with a wavelength of 9300, 9600, 10200 or 10600 nm (applied using a CO₂ laser) and near-infrared (NIR) radiation with a wavelength of 950 to 1100 nm. For calcined kaolin, the application of the UV radiation with a wavelength of from 10 to 400 nm such as from 250 to 370 or 405 nm, or infrared (IR) radiation with a wavelength of from 700 nm to 1 mm, including near-infrared (NIR) radiation with a wavelength of from 700 to 1600 nm such as infrared (IR) radiation with a wavelength of 9300, 9600, 10200 or 10600 nm (applied using a CO₂ laser) facilitates the formation of a white mark or image, or shade thereof, and application of the near-infrared (NIR) radiation with a wavelength of 700 to 1600 nm such as NIR radiation with a wavelength of 950 to 1100 nm facilitates the formation of a black, grey, or brown mark or image, or shade thereof.

When the colour-forming compound is kaolin such as calcined kaolin, preferably, the radiation is selected from infrared (IR) radiation with a wavelength of from 700 nm to 1 mm, including near-infrared (NIR) radiation with a wavelength of from 700 to 1600 nm, such as infrared (IR) radiation with a wavelength of 9300, 9600, 10200 or 10600 nm (applied using a CO₂ laser) and near-infrared (NIR) radiation with a wavelength of 700 to 1600 nm, or even 950 to 1100 nm, and the plastic product is formed of a plastic material comprising PET, r-PET or PET-G.

When the colour-forming compound is sodium molybdate dihydrate, preferably, the radiation is infrared (IR) radiation with a wavelength of from 700 nm to 1 mm, such as infrared (IR) radiation with a wavelength of 9300, 9600, 10200 or 10600 nm (applied using a CO₂ laser), and preferably the plastic product is formed of a plastic material comprising PET, r-PET or PET-G.

When the colour-forming compound is a diacetylene, preferably the radiation is UV radiation with a wavelength of from 10 to 400 nm, such as from 250 to 370 or 405 nm. As discussed above, the UV radiation may be followed by infrared (IR) radiation with a wavelength of from 700 nm to 1 mm, including near-infrared (NIR) radiation with a wavelength of from 700 to 1600 nm, such as infrared (IR) radiation with a wavelength of 9300, 9600, 10200 or 10600 nm (applied using a CO₂ laser) and near-infrared (NIR) radiation with a wavelength of 700 to 1600 nm, or even 950 to 1100 nm to facilitate formation of a different colour.

When the colour-forming compound is a leuco dye, preferably the radiation is infrared (IR) radiation with a wavelength of from 700 nm to 1 mm, such as infrared (IR) radiation with a wavelength of 9300, 9600, 10200 or 10600 nm (applied using a CO₂ laser).

It will be appreciated that when an NIR absorber is also present in the plastic product or plastic material according to the present invention, as noted above, this aids the absorption of NIR or IR radiation by the plastic product. Accordingly, when an NIR absorber is present in the plastic product, infrared (IR) radiation with a wavelength of from 700 nm to 1 mm including near-infrared (NIR) radiation with a wavelength of from 700 to 1600 nm, such as IR radiation with a wavelength of from 700 nm to 1 mm including near-infrared (NIR) radiation with a wavelength of from 700 to 1600 nm, or even near-infrared (NIR) radiation with a wavelength of 700 to 1600 nm, or even 950 to 1100 nm, or infrared (IR) radiation with a wavelength of 9300, 9600, 10200 or 10600 nm (applied using a CO₂ laser), may typically be used, or additionally be used, to form a mark or image on the plastic product of the present invention. For example, when sodium molybdate dihydrate, ammonium pentaborate tetrahydrate, ammonium pentaborate octahydrate or potassium bicarbonate is the colour-forming compound incorporated into the plastic product and an NIR absorber is also present, the radiation may be selected from infrared (IR) radiation with a wavelength of from 700 nm to 1 mm including near-infrared (NIR) radiation with a wavelength of from 700 to 1600 nm, such as infrared (IR) radiation with a wavelength of 9300, 9600, 10200 or 10600 nm (applied using a CO₂ laser) and near-infrared (NIR) radiation with a wavelength of 700 to 1600 nm, such as 950 to 1100 nm, to form a mark or image.

The radiation may be applied to the plastic product by any suitable means. Suitable means include application of radiation by a laser source(s), lamp or LED. Preferably, the radiation is applied from a laser source(s). It will be understood by a skilled person that the radiation may be applied to localised positions in a region or portion of the plastic product to selectively facilitate the formation of colour, and thus a mark or image, at these localised positions. These localised positions may overlap with each other. It will also be understood by a skilled person that the radiation is applied for an appropriate amount of time required to facilitate the formation of the mark or image. Typically, the time required to deliver sufficient radiation will depend upon the means used to apply radiation and the method of application. For example, in one embodiment, the radiation may be applied for less than 30 seconds, such as less than 20 seconds or 15 seconds, or even less than 10 or 5 seconds.

It will be appreciated that when applied using a laser source(s), the radiation dosage applied can be controlled by alteration of the time for which the radiation is applied, the power of the means used to apply the radiation (wattage) and thus, the fluence (amount of energy delivered per unit area) delivered by a laser source(s), e.g. J/cm². It will be appreciated by a skilled person that this may affect the density/opacity i.e. ‘effectiveness’ of the mark or image formed. For example, where a laser source(s) is used to apply the radiation, the fluence (amount of energy delivered per unit area) may affect the density/opacity i.e. ‘effectiveness’ of the mark or image formed. In the context of the present invention, the fluence is dependent upon the power of the means used to apply the radiation (wattage), and the time for which the radiation is applied to a particular localised position on the portion of the plastic product, which may be controlled by the scanning speed of the laser or the speed of the moving stage. These two variables can be altered to change the fluence. Where the fluence is low (e.g. lower power and/or shorter irradiation times), the mark or image formed will have lower density/lower opacity, and where the fluence is high (e.g. higher power and/or longer irradiation times), the mark or image formed will have a higher density/higher opacity. In the context of the present invention, fluence values may range from 0.01 to 100 J/cm², such as from 0.1 to 50 J/cm², and even from 0.5 to 25 J/cm².

Without being bound by theory, the present inventors consider that when the radiation is applied by a laser source(s), the concentrated energy of the radiation facilitates the formation of the mark(s) or image(s).

For the present invention, other than being visually identifiable-human and/or machine readable, the opacity or ‘effectiveness’ of the mark or image may be demonstrated by measurement of an opacity value. This is particularly relevant when the mark or image formed is white, or a shade thereof, in colour. As used herein, opacity is a measure of the impenetrability of the plastic product to light, in this instance, visible light. Opacity is expressed as a percentage from transparent (0%) to opaque (100%). The percentage is a measure of the amount of light that does not pass through the plastic product, i.e. at 0% opacity, the plastic product is completely transparent as 0% of the light does not pass through the plastic product, and at 100% opacity, the plastic product is completely opaque as 100% of the light does not pass through the plastic product. In the context of the present invention, opacity values of the areas of the plastic product to which radiation has been applied (mark or image) and the areas of the plastic product to which the radiation has not been applied (background) can be measured in order to demonstrate the effective formation of a discernible human and/or machine-readable mark or image. It will be appreciated by a skilled person that in the context of the present invention, the opacity of the mark or image is typically greater than the opacity of the background, such that a discernible human and/or machine-readable mark or image is formed. The greater the difference between the opacity values of the mark or image and the background, the more distinct and discernible the mark or image may be. The background of plastic product, i.e. the part(s) of the plastic product to which the radiation has not been applied may have an opacity of 20% or less, such as from 15% or less, preferably 10% or less, or even 5% or less. Further, the localised areas of the plastic product to which the radiation has been applied and a mark or image formed thereon may have an opacity of 40% or more, such as 45% or more, preferably 50% or more, or even 60% or more, such as 70% or more. It will be appreciated that the higher the opacity value of the mark image, the more distinct and discernible the mark or image formed. A high opacity value thus denotes effective mark or image formation. Alternatively, if the opacity of the background and the mark or image are not contrasting enough, a distinct and discernible mark or image may still be formed if the colours of the background and the mark or image are contrasting. In the context of the present invention, opacity measurements may be made using the opacity function of a Techkon SpectroDens spectrophotometer according to ASTM standard ASTM D589-97, and the marked or imaged (mark or image) and unmarked or unimaged (background) areas of the plastic product may be each measured relative to black and white standards. It will be appreciated that for such measurements, sections of the plastic product will typically need to be cut out.

For the present invention, other than being visually identifiable-human and/or machine readable, the density of the mark or image may be demonstrated by measurement of ODB, ODC, ODM and ODY values. This is particularly useful when the mark or image formed is black, red, magenta, cyan or yellow, or a shade thereof. In the context of the present invention, the mark or image will be a contrasting image. By “contrasting image” is meant that the mark or image formed is distinct and easily discernible. Preferably, the mark or image formed has an absolute ODB, ODC, ODM or ODY value of 0.5 or more, such as 0.7 or more, or even 0.8 or more, such as 0.9 or more, or 1.0 or more. An absolute ODB, ODC, ODM or ODY value of 0.5 or more provides a contrasting image that is distinct and easily discernible. The absolute ODB (optical density black) value measures the optical density of the black colour of the mark or image. This is useful when the mark or image formed is black in colour, or a shade thereof. The absolute ODM (optical density magenta) value measures the optical density of the magenta colour of the image. This is useful when the mark or image formed is red in colour, or a shade thereof. The absolute ODC (optical density cyan) value measures the optical density of the cyan colour of the image. This is useful when the mark or image formed is blue in colour, or a shade thereof. The absolute ODY (optical density yellow) value measures the optical density of the yellow colour of the image. This is useful when the mark or image formed is red in colour, or a shade thereof. In the context of ODB, ODM, ODC and ODY values, the higher the value, the darker the colour formed. The absolute ODB, ODM, ODC and ODY value quantifies the optical density on the respective colour scale from low to high values, where ODB, ODM, ODC and ODY measurements can be made using a standard instrument densitometer and X-Rite exact or SpectroEye or TechKon SpectroDens spectrophotometer. The difference, ΔODB, ΔODM, ΔODC or ΔODY in measured optical density between the mark or image (absolute ODB, ODM, ODC or ODY value) and the ‘background’, i.e. the part(s) of the plastic product that have not been exposed to radiation (background ODB, ODM, ODC or ODY) can also be measured.

For the present invention, other than being visually identifiable-human and/or machine readable, the density of the mark or image may be determined by measurement of ΔE values using an X-Rite exact or SpectroEye spectrophotometer. ΔE may be calculated from L*a*b* measurements (CIE L*a*b* colour system, L* denotes lightness, a* denotes the red/green values, and b* denotes the yellow/blue values). ΔE is a standard mathematical calculation which allows for the quantification of the visual perception of the difference between two colours i.e. between the mark or image and the ‘background’. The calculation is given below:

$$Δ E = \sqrt{{( {L}_{1} - {L}_{2} )}^{2} + {( {a}_{1} - {a}_{2} )}^{2} + {( {b}_{1} - {b}_{2} )}^{2}}$$

For the present invention, a value of ΔE of greater than 3, such as greater than 5 would demonstrate a distinct and distinguishable contrasting image.

Preferably, the radiation is applied to the plastic product at localised positions in order to form a desired mark or image at these localised positions. Essentially, upon application of the radiation, preferably from a laser source(s), lamp or LED, a colour is formed at the areas of the plastic product to which the radiation is applied. A human and/or machine readable mark or image is thus generated. It is the colour-forming compound that enables a mark or image to be formed on and within the plastic product.

All of the features contained herein may be combined with any of the above aspects in any combination.

All references to particular chemical compounds herein are to be interpreted as covering the compounds per se, and also, where appropriate, derivatives, hydrates, solvates, complexes, isomers and tautomers thereof.

For a better understanding of the present invention, and to show how embodiments of the same may be carried into effect, reference will now be made, by way of example, to the following experimental data.

### EXAMPLES

Sodium molybdate dihydrate (CAS Number: 10102-40-6, EC Number: 231-551-7) was purchased from ABSCO Limited, UK. The sodium molybdate dihydrate is a granular crystalline solid with a typical average particle size of >149 μm (>100 mesh).

Ammonium pentaborate tetrahydrate (CAS No. 12046-04-7) was purchased from Merck Sigma Aldrich Limited, UK. The ammonium pentaborate tetrahydrate is a crystalline solid in powder form.

Low Density Polyethylene (LDPE) pellets Exxon Mobil 600BA were purchased from Colourmaster Limited, UK.

Ammonium octamolybdate (AOM) (CAS Number: 12411-64-2) was purchased. The ammonium octamolybdate is a solid in powder form with a D50 of 1 to 3 microns.

Calcined kaolin (CAS Number: 92704-41-1) was purchased from Merck Sigma Aldrich Limited, UK. The calcined kaolin is a solid in powder form.

Polyethylene Terephthalate (PET) powder PR12747 was purchased from Colourmaster Limited, UK.

Blue indium tin oxide (ITO) (CAS Number: 1312-43-2/18282-10-5) was purchased from Keeling & Walker Limited, UK. The ITO is a crystalline solid in powder form.

High density polyethylene (HDPE) pellets Sibur Natural HD85612 IM were purchased from Colourmaster Limited, UK

Polypropylene (PP) pellets SABIC PP PHC31 00900 were purchased from Colourmaster Limited, UK.

Polyethylene terephthalate (PET)-compatible liquid masterbatch was provided by Riverdale Global Limited, UK.

Polypropylene (PP)-compatible liquid masterbatch was provided by Riverdale Global Limited, UK.

High Density Polyethelene (HDPE)-compatible liquid masterbatch was provided by Riverdale Global Limited, UK.

Ammonium sulphate (CAS No. 7783-20-2) was purchased from Merck Sigma Aldrich Limited, UK. The ammonium sulphate is a solid in powder form.

6-dimethylamino-3,3-bis(4-dimethylaminophenyl) phthalide (CAS Number: 1552-42-7) is purchasable from Sigma Aldrich. This leuco dye is a solid in powder form.

Canary Yellow OM1700 Masterbatch was purchased from Colourmaster Limited, UK.

Ultra Blue OM5179 Masterbatch was purchased from Colourmaster Limited, UK.

RIT Dye Daffodil Yellow 2118 was purchased from Dyeing for Change, UK.

### Example 1: General Method for Forming and Imaging a Plastic Product

Sodium molybdate dihydrate was milled using an ‘opposed jet mill’ as operated by British REMA to achieve particles having a volume-weighted mean diameter D[4,3] of 3 to 7 μm, powder form. The milled sodium molybdate dihydrate particles in powder form were incorporated into a carrier to form a ‘liquid concentrate or masterbatch’. This ‘liquid concentrate or masterbatch’ was brought into contact (injected into) and incorporated into molten polyethylene terephthalate (PET) as the plastic material such that the sodium molybdate dihydrate particles were fully and homogenously dispersed throughout the polyethylene terephthalate (PET).

The molten polyethylene terephthalate (PET) having the sodium molybdate dihydrate particles incorporated therein was injection molded to produce a bottle preform (a plastic product of the present invention) formed of polyethylene terephthalate (PET) having sodium molybdate dihydrate incorporated therein.

The bottle preform was then blow molded to produce a plastic bottle. Accordingly, a plastic bottle (a plastic product of the present invention) formed of polyethylene terephthalate (PET) having sodium molybdate dihydrate incorporated therein was formed. Infrared (IR) radiation was applied to localised positions in a portion of the plastic bottle using a Videojet VJ-3320 SHC-60 CO₂ Laser at 10.6 μm wavelength and for example, 64, 95 or 127 mm lens setup, to from a white image at these localised positions.

### Example 2

500 g of ammonium pentaborate tetrahydrate was combined with 4,500 g of LDPE pellets and tumble blended to form a mixture. The solid mixture was poured into a Brabender feed hopper and, using the feed screw, dosed gradually into the feed throat of a Rondol twin-screw extruder. The heating zones were set at temperatures of 140° C. (Zone 1), 200° C. (Zone 5) and 190° C. (Die) and the mixture melt extruded to form an initial masterbatch containing 10 wt. % ammonium pentaborate tetrahydrate. This initial masterbatch was cooled using a chilled water bath and then pelletised using an Accrapal 750/3 Free-standing Strand Dry Cut Pelletizer. The pellets were collected and dried for several hours using Drymaster apparatus to form a solid masterbatch containing 10 wt. % ammonium pentaborate tetrahydrate.

The pellets of the solid masterbatch were loaded into the feed hopper of an Arburg Allrounder 420° C. injection molder and plastic plaques having ammonium pentaborate tetrahydrate incorporated therein were produced. The plastic plaques had an off-white haze/cloudiness inherent to LDPE (background coour). The present inventors consider that the formation of the plastic plaques through injection molding substantially replicates the manufacture and processing conditions required during production of a plastic product according to the present invention.

IR radiation was applied to the plastic plaque using a Videojet VJ-3320 CO₂ laser and a clear and distinct white mark or image was formed at the localised positions to which the radiation was applied.

### Example 3

500 g of AOM was combined with 4,500 g of LDPE pellets and tumble blended to from a mixture. The solid mixture was poured into a Brabender feed hopper and, using the feed screw, dosed gradually into the feed throat of a Rondol twin-screw extruder. The heating zones were set at temperatures of 140° C. (Zone 1) 200° C. (Zone 5) and 190° C. (Die) and the mixture was melt extruded to form an initial masterbatch containing 10 wt. % AOM. The initial masterbatch was cooled using a chilled water bath and then pelletised using an Accrapak 750/3 Free-standing Strand Dry Cut Pelletiser. The pellets were collected and dried for several hours using Drymaster apparatus to form a solid masterbatch containing 10 wt. % ammonium octamolybdate.

### Example 3.1

The pellets of the solid masterbatch were taken and loaded into the feed hopper of an Arburg Allrounder 420C injection moulder and plastic plaques having AOM incorporated therein were produced. The plastic plaques had an off-white haze/cloudiness inherent to LDPE (‘background’ colour).

IR radiation was applied to the plastic plaques using a Videojet VJ-3320 CO₂ laser and a black mark or image was formed. NIR radiation (both continuous and pulsed) was applied to the plastic plaques using a Macsa F-9020 (Continuous Wave) Fibre Laser and an IPG YLPN-30 (Pulsed) Fibre Laser and a black mark or image was formed. UV radiation was applied to the plastic plaques using a Coherent 355 nm UV laser and a black mark or image was formed.

### Example 3.2

2 kg of the solid masterbatch containing 10 wt. % AOM was processed with 24.7 kg of Marlex HHM 5502BN Virgin HDPE and 13.3 kg of SIRENE HD E 80 PWP rHDPE (post-consumer Recycled HDPE) as a 65:35 Virgin HDPE:rHDPE mix to produce 500 mL tall Boston round (TBR) plastic bottles by extrusion blow moulding. The plastic bottles formed contained 5 wt. % solid masterbatch and 0.5 wt. % AOM. The plastic bottles had an off-white haze/cloudiness inherent to LDPE and HDPE (‘background’ colour).

IR radiation was applied to the plastic bottles using a Videojet VJ-3320 CO₂ laser and a black mark or image was formed. NIR radiation (both continuous and pulsed) was applied to the plastic bottles using a Macsa F-9020 (Continuous Wave) Fibre Laser and an IPG YLPN-30 (Pulsed) Fibre Laser and a black mark or image was formed. UV radiation was applied to the plastic bottles using a Coherent 355 nm UV laser and a black mark or image was formed.

### Example 4

500 g of calcined kaolin was combined with 4,500 g of PET powder and tumble blended to form a mixture. The solid mixture was poured into a Brabender feed hopper and, using the feed screw, dosed gradually into the feed throat of a Rondol twin-screw extruder. The heating zones were set at temperature of 150° C. (Zone 1) 220° C. (Zone 6) and 200° C. (Die) and the mixture melt extruded to form an initial masterbatch containing 10 wt. % calcined kaolin. The initial masterbatch was cooled using a chilled water bath and then pelletised using an Accrapak 750/3 Free-standing Strand Dry Cut Pelletiser. The pellets were collected and dried for several hours using Drymaster apparatus to form a solid masterbatch containing 10 wt. % calcined kaolin.

The pellets of the solid masterbatch were taken and loaded into the feed hopper of an Arburg Allrounder 420C injection moulder and plastic plaques having calcined kaolin incorporated therein were produced. The plastic plaques had an off-white haze/cloudiness (‘background’ colour).

IR radiation was applied to the plastic plaques using a Videojet VJ-3320 CO₂ laser and a white mark or image was formed. NIR radiation (both continuous and pulsed) was applied to the plastic plaques using a Macsa F-9020 (Continuous Wave) Fibre Laser and an IPG YLPN-30 (Pulsed) Fibre Laser and a black mark or image was formed. UV radiation was applied to the plastic bottles using a Coherent 355 nm UV laser and a white mark or image was formed.

### Example 5

475 g of ammonium pentaborate tetrahydrate and 25 g ITO were blended using a Nutribullet electromechanical high-speed blender to produce a powder mixture. 500 g of the mixture was combined with 4,500 g of LDPE pellets and tumble blended to form a solid mixture. The solid mixture was poured into a Brabender feed hopper and, using the feed screw, dosed gradually into the feed throat of a Rondol twin-screw extruder. The heating zones were set at temperatures of 140° C. (Zone 1) 200° C. (Zone 5) and 190° C. (Die) and the mixture melt extruded to form an initial masterbatch containing 10 wt. % mixed ammonium pentaborate tetrahydrate and ITO (9.5 wt % ammonium pentaborate tetrahydrate and 0.5 wt. % ITO). The initial masterbatch was cooled using a chilled water bath and then pelletised into granules using an Accrapak 750/3 Free-standing Strand Dry Cut Pelletiser. The pellets were collected and dried for several hours using Drymaster apparatus to form a solid masterbatch containing 10 wt. % mixed ammonium pentaborate tetrahydrate and ITO.

The pellets of the solid masterbatch were taken and loaded into the feed hopper of an Arburg Allrounder 420C injection moulder and plastic plaques having ammonium pentaborate tetrahydrate and ITO incorporated therein were produced. The plastic plaques had an off-white haze/cloudiness inherent to LDPE with a blue tint/shade from NIR absorber (‘background’ colour).

IR radiation was applied to the plastic plaques using a Videojet VJ-3320 CO₂ laser and a white mark or image was formed. NIR radiation (both continuous and pulsed) was applied to the plastic plaques using a Macsa F-9020 (Continuous Wave) Fibre Laser and an IPG YLPN-30 (Pulsed) Fibre Laser and a white mark or image was formed.

### Examples 6 and 7

Example 5 was repeated but the LDPE pellets were replaced with HDPE pellets (Example 6) and PP pellets (Example 7) respectively. White marks or images were formed.

### Example 8

475 g of AOM and 25 g of ITO were blended using a Nutribullet electromechanical high-speed blender to produce a powder mixture. 500 g of the AOM and ITO mixture was combined with 4,500 g of LDPE pellets and tumble blended to form a solid mixture. The solid mixture was poured into a Brabender feed hopper and, using the feed screw, dosed gradually into the feed throat of a Rondol twin-screw extruder. The heating zones were set at temperatures of 140° C. (Zone 1) 200° C. (Zone 5) and 190° C. (Die) and the mixture melt extruded to form an initial masterbatch containing 10 wt. % mixed AOM and ITO (9.5 wt % AOM and 0.5 wt. % ITO). The initial masterbatch was cooled using a chilled water bath and then pelletised into granules using an Accrapak 750/3 Free-standing Strand Dry Cut Pelletiser. The pellets were collected and dried for several hours using Drymaster apparatus to form a solid masterbatch containing 10 wt. % mixed AOM and ITO.

The pellets of the solid masterbatch were taken and loaded into the feed hopper of an Arburg Allrounder 420C injection moulder and plastic plaques having AOM and ITO incorporated therein were produced. The plastic plaques had a had an off-white haze/cloudiness inherent to LDPE with a blue tint/shade from NIR absorber (‘background’ colour).

IR radiation was applied to the plastic plaques using a Videojet VJ-3320 CO₂ laser and a black mark or image was formed. NIR radiation (both continuous and pulsed) was applied to the plastic plaques using a Macsa F-9020 (Continuous Wave) Fibre Laser and an IPG YLPN-30 (Pulsed) Fibre Laser and a black mark or image was formed. UV radiation was applied to the plastic plaques using a Coherent 355 nm UV laser and a black mark or image was formed.

### Examples 9 and 10

Example 8 was repeated but the LDPE pellets were replaced with HDPE (Example 9) or PP (Example 10). Black marks or images were formed.

### Example 11

11.875 kg of AOM and 625 g ITO were blended using a Nutribullet electromechanical high-speed blender to produce a powder mixture. 12.5 kg of the mixed AOM and ITO was combined with 12.5 kg of LDPE pellets and tumble blended to form a mixture. The solid mixture was poured into a Brabender feed hopper and, using the feed screw, dosed gradually into the feed throat of a Rondol twin-screw extruder. The heating zones were set at temperatures of 140° C. (Zone 1) 200° C. (Zone 5) and 190° C. (Die) and the mixture melt extruded to form an initial masterbatch containing 50 wt. % mixed AOM and ITO (47.5 wt. % AOM and 2.5 wt. % ITO). The initial masterbatch was cooled using a chilled water bath and then pelletised into granules using an Accrapak 750/3 Free-standing Strand Dry Cut Pelletiser. The pellets were collected and dried for several hours using Drymaster apparatus to form a solid masterbatch containing 50 wt. % mixed AOM and ITO.

2 kg of the pellets of the solid masterbatch were processed with 24.7 kg of Marlex HHM 5502BN Virgin HDPE and 13.3 kg of SIRENE HD E 80 PWP rHDPE (post-consumer recycled HDPE) as a 65:35 solid HDPE mix (virgin HDPE:rHDPE) to produce 500 mL tall Boston round (TBR) bottles by extrusion blow molding. The plastic bottles formed contained 5 wt. % solid masterbatch and 2.5 wt. % AOM and ITO (2.375 wt % AOM and 0.125 wt % ITO). The plastic bottles had an off-white haze/cloudiness inherent to LDPE and HDPE with a blue tint/shade from NIR absorber (‘background’ colour).

IR radiation was applied to the plastic bottles using a Videojet VJ-3320 CO₂ laser and a black mark or image was formed. NIR radiation (both continuous and pulsed) was applied to the plastic bottles using a Macsa F-9020 (Continuous Wave) Fibre Laser and an IPG YLPN-30 (Pulsed) Fibre Laser and a black mark or image was formed. UV radiation was applied to the plastic bottles using a Coherent 355 nm UV laser and a black mark or image was formed.

### Example 12

450 g of calcined kaolin and 50 g of ITO were blended using a Nutribullet electromechanical high-speed blender to produce a mixture. 500 g of the mixed calcined kaolin and ITO was combined with 4,500 g PET powder and tumble blended to form a mixture. The solid mixture was poured into a Brabender feed hopper and, using the feed screw, dosed gradually into the feed throat of a Rondol twin-screw extruder. The heating zones were set at temperatures of 150° C. (Zone 1) 220° C. (Zone 6) and 200° C. (Die) and the mixture was melt extruded to form an initial masterbatch containing 10 wt. % mixed calcined kaolin and ITO (9 wt. % calcined kaolin and 1 wt. % ITO). The initial masterbatch was cooled using a chilled water bath and then pelletised using an Accrapak 750/3 Free-standing Strand Dry Cut Pelletiser. The pellets were collected and dried for several hours using Drymaster apparatus to form a solid masterbatch containing 10 wt. % mixed calcined kaolin and ITO.

The pellets of the solid masterbatch were taken and loaded into the feed hopper of an Arburg Allrounder 420C injection moulder and plastic plaques containing calcined kaolin and ITO were produced. The plastic plaques had an off-white haze/cloudiness with a blue tint/shade from NIR absorber (‘background’ colour).

IR radiation was applied to the plastic plaques using a Videojet VJ-3320 CO₂ laser and a white mark or image was formed. NIR radiation (both continuous and pulsed) was applied to the plastic plaques using a Macsa F-9020 (Continuous Wave) Fibre Laser and an IPG YLPN-30 (Pulsed) Fibre Laser and a black mark or image was formed. UV radiation was applied to the plastic plaques using a Coherent 355 nm UV laser and a white mark or image was formed.

### Example 13

7.2 kg of calcined kaolin and 800 g of ITO were blended using a Nutribullet electromechanical high-speed blender to produce a powder mixture. 8 kg of the mixed calcined kaolin and ITO was combined with 12 kg of PET powder and the mixture was melt extruded to form an initial masterbatch containing 40 wt. % calcined kaolin. The initial masterbatch was cooled using a chilled water bath and then pelletised. The pellets were collected and dried to from a solid masterbatch containing 40 wt. % mixed calcined kaolin and ITO (36 wt. % calcined kaolin and 4 wt. % ITO).

2 kg of the solid masterbatch was processed with 42.0 kg of Virgin PET and 22.6 kg of rPET (post-consumer recycled PET) as a 65:35 PET mix (virgin PET:rPET) to produce 500 mL tall Boston round (TBR) bottles by extrusion blow molding. The plastic bottles formed contained 3 wt. % solid masterbatch and 1.2 wt. % mixed calcined kaolin and ITO (1.08 wt. % calcined kaolin and 0.12 wt. % ITO). The plastic bottles had an off-white haze/cloudiness with a blue tint/shade from NIR absorber (‘background’ colour).

IR radiation was applied to the plastic bottles using a Videojet VJ-3320 CO₂ laser and a white mark or image was formed. NIR radiation (both continuous and pulsed) was applied to the plastic bottles using a Macsa F-9020 (Continuous Wave) Fibre Laser and an IPG YLPN-30 (Pulsed) Fibre Laser and a black mark or image was formed. UV radiation was applied to the plastic bottles using a Coherent 355 nm UV laser and a white mark or image was formed.

### Example 14

475 g of AOM and 25 g of ITO were blended using a Nutribullet electromechanical high-speed blender to produce a powder mixture. 500 g of the mixed AOM and ITO was combined with 214 g of a PET-compatible liquid masterbatch to form a liquid masterbatch containing 70 wt. % AOM and ITO (66.5 wt. % AOM and 3.5 wt. % ITO).

The liquid masterbatch was taken and dosed into molten PET from pellets using a Boy 22S injection moulder and plastic plaques were produced. The plastic plaques contained 0.7 wt. % liquid masterbatch and 0.49 wt. % of the mixed AOM and ITO (0.4655 wt. % AOM and 0.0245 wt. % ITO). The plastic plaques had a black/grey colour (‘background’ colour).

IR radiation was applied to the plastic plaques using a Videojet VJ-3320 CO₂ laser and a white mark or image was formed. NIR radiation (both continuous and pulsed) was applied to the plastic plaques using a Macsa F-9020 (Continuous Wave) Fibre Laser and an IPG YLPN-30 (Pulsed) Fibre Laser and a white mark or image was formed. UV radiation was applied to the plastic plaques using a Coherent 355 nm UV laser and a white mark or image was formed.

### Example 15

475 g of AOM and 25 g of ITO were blended using a Nutribullet electromechanical high-speed blender to produce a powder mixture. 500 g of the mixed AOM and ITO was combined with 214 g of a PP-compatible liquid masterbatch to form a liquid masterbatch containing 70 wt. % AOM (66.5 wt. % AOM and 3.5 wt. % ITO).

The liquid masterbatch was taken and dosed into molten PP from pellets using a Boy 22S injection moulder and plastic plaques were produced. The plastic plaques contained 0.7 wt. % liquid masterbatch and 0.49 wt. % of the mixed AOM and ITO (0.4655 wt. % AOM and 0.0245 wt. % ITO). The plastic plaques had an off-white colour (‘background’ colour).

IR radiation was applied to the plastic plaques using a Videojet VJ-3320 CO₂ laser and a dark grey mark or image was formed. NIR radiation (both continuous and pulsed) was applied to the plastic plaques using a Macsa F-9020 (Continuous Wave) Fibre Laser and an IPG YLPN-30 (Pulsed) Fibre Laser and a grey mark or image was formed. UV radiation was applied to the plastic plaques using a Coherent 355 nm UV laser and a grey mark or image was formed.

### Example 16

450 g of calcined Kaolin and 50 g of ITO were blended using a Nutribullet electromechanical high-speed blender to produce a powder mixture. 500 g of the mixed calcined kaolin and ITO was combined with 214 g PET-compatible liquid masterbatch to form a liquid masterbatch containing 70 wt. % calcined kaolin (63 wt. % calcined kaolin and 7 wt. % ITO).

The liquid masterbatch was taken and dosed into molten PET from pellets using a Boy 22S injection moulder and plastic plaques were produced. The plastic plaques contained 0.7 wt. % of the liquid masterbatch and 0.49 wt. % of the mixed calcined kaolin and ITO (0.441 wt. % AOM and 0.049 wt. % ITO). The plastic plaques were colourless.

IR radiation was applied to the plastic plaques using a Videojet VJ-3320 CO₂ laser and a white mark or image was formed. NIR radiation (both continuous and pulsed) was applied to the plastic plaques using a Macsa F-9020 (Continuous Wave) Fibre Laser and an IPG YLPN-30 (Pulsed) Fibre Laser and a black mark or image was formed. UV radiation was applied to the plastic plaques using a Coherent 355 nm UV laser and a white mark or image was formed.

### Example 17

475 g of ammonium pentaborate tetrahydrate and 25 g of ITO were blended using a Nutribullet electromechanical high-speed blender to produce a powder mixture. 500 g of the mixed ammonium pentaborate tetrahydrate and ITO was combined with 214 g of HDPE-compatible liquid masterbatch containing 70 wt. % ammonium pentaborate tetrahydrate and ITO.

500 g of the liquid masterbatch was milled with recirculation using an electromechanical Eiger Torrance bead mill with 1.5 mm Yttria Zirconia ceramic beads.

The milled liquid masterbatch was taken and dosed into molten HDPE from pellets using a Boy 22S injection moulder and plastic plaques were produced. The plastic plaques had an off-white haze/cloudiness inherent to HDPE with a blue tint/shade from NIR absorber (‘background’ colour).

IR radiation was applied to the plastic plaques using a Videojet VJ-3320 CO₂ laser and a white mark or image was formed.

### Example 18

Sodium molybdate dihydrate was milled using an ‘opposed jet mill’ as operated by British REMA to achieve particles having a volume-weighted mean diameter D[4,3] of 3 to 7 μm, powder form. 15 g of sodium molybdate dihydrate was mixed with 50 g LDPE pellets to form a plastic plaque using the CR Clarke Manual Injection Moulding machine at 190° C. The plastic plaque had an off-white haze/cloudiness inherent to LDPE.

IR radiation was applied to the plastic plaque using a Videojet VJ-3320 CO₂ laser and a white mark or image was formed.

### Example 19

3 g of diacetylene (N1,N22-didodecyldocosa-10,12-diynediamide) was mixed with 60 g of LDPE pellets to form a plastic plaque using a CR Clarke Manual Injection Moulding machine at 200° C.

UV radiation was applied to a portion of the plastic plaque (the remaining portion being blocked from the UV radiation) using a UV 254 nm lamp and a blue mark or image was formed.

### Example 20

Combination particles of AOM and ITO were formed as follows:

500 mL deionized water, 500 g AOM and a magnetic stirrer bar were added into a 2 L jug. The jug was placed on a stirrer hotplate with temperature set to 60° C. and stirrer speed set to 500 rpm. Once up to temperature, 25% ammonia solution was added until 250 g was reached. The white opaque dispersion became a pale solution (more ammonia solution can be added if necessary. Once full solubilization had taken place, stirrer bar was removed and the solution mixed under Silverson high shear mixer at 3000 rpm taking care to ensure beaker is not pulled up to the mixer head. 25 g ITO was added into the AOM solution and mixed for 5 minutes or until dispersed. The beaker was removed from the Silverson and stirrer bar added back in. The beaker was then returned to the stirrer hot plate set to 500 rpm, no heating. 500 g of ethanol was added to crash out the solid by quenching ammonia. The stirrer bar was removed using pliers. The mixture was cooled in a freezer until below 5° C. The excess solvent was decanted and an additional 500 mL ethanol added and then mixed under Silverson at 3000 rpm for 5 minutes. The mixture was gravity filtered and the filter paper containing the damp solid removed and placed in a borosilicate tray and dried in a vacuum oven set to 60° C. (the solid should be dried until free of moisture and ammonia). The solid formed large agglomerates in the drying process. These were ground using a nutribullet until a fine powder was formed.

500 g of the combination particles of AOM: ITO was combined with 4500 g of LDPE pellets and tumble blended to form a powdery pellet mixture. The solid mixture was poured into a Brabender feed hopper and using the feed screw dosed gradually into the feed throat of a Rondol twin-screw extruder. The heating zones were set at temperatures of 140° C. (Zone 1), 200° C. (Zone 5), and 190° C. (Die). The mixture was melt extruded to form an initial masterbatch comprising 10 wt. % combined AOM and ITO. The initial masterbatch was cooled using a chilled water bath and then pelletised using an Accrapak 750/3 Free-standing Strand dry cut Pelletiser. The pellets were collected and then dried for several hours using Drymaster apparatus to form a solid masterbatch containing 10 wt % combined AOM and ITO.

The pellets of the solid masterbatch were taken and loaded into the feed hopper of an Arburg Allrounder 420C injection moulder and plastic plaques containing combined AOM and ITO were produced. The plastic plaques had an off-white haze/cloudiness with a blue tint/shade from NIR absorber (‘background’ colour).

IR radiation was applied to the plastic plaques using a Videojet VJ-3320 CO₂ laser and a black mark or image was formed. NIR radiation (both continuous and pulsed) was applied to the plastic plaques using a Macsa F-9020 (Continuous Wave) Fibre Laser and an IPG YLPN-30 (Pulsed) Fibre Laser and a black mark or image was formed. UV radiation was applied to the plastic plaques using a Coherent 355 nm UV laser and a black mark or image was formed.

### Example 21

Combination particles of leuco dye, acid-generating agent and ITO were formed as follows:

150 g of leuco dye (6-dimethylamino-3,3-bis(4-dimethylaminophenyl) phthalide) was added to 1500 g of acetone, while under magnetic stir of 500 RPM. The heating element was set-up to reach 30-40° C. Once the temperature of the solution reached 30° C., the leuco dye completely dissolved, turning the solution from cloudy to completely clear. Then 15 g of ITO (ground) was added to the sample stirring vortex. The sample was then subjected to high-shear from the medium-sized silverson mixer for up to 15 minutes before 555 g (sub-batch 1) of the solution mixer was decanted into another container for further processing. The remaining 1110 g of solution mixture was left for a further 15 minutes, before another 555 g (sub-batch 2) of the solution mixture was decanted for further processing. Similarly, the last portion of the 555 g (sub-batch 3) solution mixture was left for a further 15 minutes of mixing. Thus sub-batch 1 subjected to 15 minutes of silverson mixing, sub-batch 2 for 30 minutes, and sub-batch 3 for up to 45 minutes in total, all before being further processed at the crystallisation phase. Simultaneously, 840 g of pre-weighed de-ionised water was cooled to <10° C. in the freezer for up to 15-20 minutes. These last 3 steps were repeated for sub-batches 2 and 3. The crystals appeared light blue, owing to the presence of ITO. The 555 g decanted solution mixture of sub-batch 1 was placed back under magnetic stir of 500+ RPM, while being cooled to <=10° C. using an ice-water bath cooling jacket. Once the 555 g solution mixture of sub-batch 1 was sufficiently cool at or below 10° C., the pre-cooled <=10° C. de-ionised water was slowly added to the vortex, until all the water had been added. The resulting crashed mixture was then left to settle in the 5° C. fridge for up to 1 hr. Following refrigeration, each sample was buchner filtered, under suction, until the crystals with semi-dry. The crystals were then placed in the vacuum oven and left over a three-day weekend period, subjected to full vacuum and 60° C. of temperature. Following drying, the crystals were isolated.

300 g of ammonium sulphate was added to 1000 g of de-ionised water, under magnetic stir of 500 RPM and 30° C. Once the ammonium sulphate was completely dissolved, 200 g of the isolated crystals formed from the leuco dye and ITO was added to the solution, which collectively was transferred to the medium-sized silverson mixer. The sample was then subjected to high-shear from the medium-sized silverson mixer for up to 15 minutes before 500 g (sub-batch 1) of the solution mixer was decanted into another container for further processing. The remaining 1000 g of solution mixture was left for a further 15 minutes, before another 500 g (sub-batch 2) of the solution mixture was decanted for further processing. Similarly, the last portion of the 500 g (sub-batch 3) solution mixture was left for a further 15 minutes of mixing. Thus sub-batch 1 subjected to 15 minutes of silverson mixing, sub-batch 2 for 30 minutes, and sub-batch 3 for up to 45 minutes in total, all before being further processed at the crystallisation phase. While on the silverson mixer, foaming and a change in rheology was evident, resulting in stagnant flow during shear. To address this, a small amount of ethanol approximately 90-100 g was added to the collective solution mixture at the vortex and contact surfaces, which sufficiently reduced the surface tension to allow for the foam to dissipate without resulting in crashed crystals. Once flow returned to the collective solution mixture, 500 g (sub-batch 1) was decanted into another metal jug and placed back under magnetic stir of 500+ RPM, while being cooled to <=10° C. using a ice-water bath cooling jacket. Simultaneously, 1170 g of pre-weighed ethanol was cooled to <10° C. in the freezer for up to 15-20 minutes. Once the 500 g solution mixture of sub-batch 1 was sufficiently cool at or below 10° C., the pre-cooled <=10° C. ethanol was slowly added to the vortex, until all of the water had been added. The resulting crashed mixture was then left to settle in the 5° C. fridge for up to 1 hr. These last 3 steps were repeated for sub-batches 2 and 3. Following refrigeration, each sample was buchner filtered, under suction, until the crystals with semi-dry. The crystals appeared light blue, owing to the presence of ITO at the encapsulate core. The crystals were then placed in the vacuum oven and left over a two day period, subjected to full vacuum and 40° C. of temperature, with intermittent purging to remove excess humidity. Following full dry, the crystals were isolated.

500 g of the combination particles of acid-generating agent:ITO:lecuo dye were combined with 4500 g of LDPE pellets and tumble blended to form a powdery pellet mixture. The solid mixture was poured into a Brabender feed hopper and using the feed screw dosed gradually into the feed throat of a Rondol twin-screw extruder. The heating zones were set at temperatures of 140° C. (Zone 1), 200° C. (Zone 5), and 190° C. (Die) so the mixture was melt extruded to form an initial masterbatch comprising 10 wt. % combined acid-generating agent, ITO and leuco dye. The initial masterbatch was cooled using a chilled water bath and then pelletised into granules using an Accrapak 750/3 Free-standing Strand dry cut Pelletiser. The pellets were collected and then dried for several hours using Drymaster apparatus to form a solid masterbatch having 10 wt. % combined acid-generating agent, ITO and leuco dye.

The solid masterbatch pellets were taken and loaded into the feed hopper of an Arburg Allrounder 420C injection moulder and plastic plaques containing combined acid-generating agent, leuco dye and ITO were produced. The plastic plaques had an off-white haze/cloudiness with a blue tint/shade from NIR absorber (‘background’ colour).

IR radiation was applied to the plastic plaques using a Videojet VJ-3320 CO₂ laser and a blue mark or image was formed. UV radiation was applied to the plastic plaques using a Coherent 355 nm UV laser and a blue mark or image was formed.

### Example 22

11.875 kg of AOM and 625 g of ITO were blended using a Nutribullet electromechanical high-speed blender to produce a powder. 1680 g of the mixed AOM and ITO was combined with 3.12 kg of LDPE pellets and the mixture was melt extruded to form an initial masterbatch comprising 35 et. % AOM and ITO. The extruded filament was pelletised, and the pellets collected. 4800 g of the initial masterbatch was combined with 200 g of canary yellow OM1700 masterbatch pellets and tumble blended to form a pellet mixture. The solid mixture was poured into a Brabender feed hopper and using the feed screw dosed gradually into the feed throat of a Rondol twin-screw extruder. The heating zones were set at temperatures of 140° C. (Zone 1), 200° C. (Zone 5), and 190° C. (Die) and the mixture was melt extruded to an initial masterbatch comprising 4 wt. % canary yellow and 35% mixed AOM and ITO. This initial masterbatch was cooled using a chilled water bath and then pelletised into granules using an Accrapak 750/3 Free-standing strand dry cut pelletiser. The pellets were collected and then dried for several hours using Drymaster apparatus to form a solid masterbatch.

The solid masterbatch pellets were taken and loaded into the feed hopper of a CW Clarke 25 Plastic Injection Moulding, a benchtop manually operated device, and plastic plaques containing mixed AOM and ITO were produced. The plastic plaques had a yellow ‘background’ colour.

The plaques were taken and tested for laser imaging performance with a Coherent 355 nm UV Laser, a Macsa F-9020 (Continuous Wave) Fibre Laser, an IPG YLPN-30 (Pulsed) Fibre Laser and Videojet VJ-3320 CO₂ Laser.

IR radiation was applied to the plastic plaques using a Videojet VJ-3320 CO₂ laser and a black mark or image was formed. NIR radiation (both continuous and pulsed) was applied to the plastic plaques using a Macsa F-9020 (Continuous Wave) Fibre Laser and an IPG YLPN-30 (Pulsed) Fibre Laser and a black mark or image was formed. UV radiation was applied to the plastic plaques using a Coherent 355 nm UV laser and a black mark or image was formed.

### Example 23

11.875 kg ammonium pentaborate dihydrate and 625 g of ITO were blended using a Nutribullet electromechanical high-speed blender to produce a powder. 1680 g of the mixed ammonium pentaborate tetrahydrate and ITO was combined with 3.12 kg of LDPE pellets and the mixture was melt extruded to form an initial masterbatch comprising 35 wt. % mixed ammonium pentaborate and ITO. The initial masterbatch was pelletised, and the pellets were collected. 4800 g of the initial masterbatch was combined with 200 g of ultra blue OM5179 masterbatch pellets and tumble blended to form a pellet mixture. The solid mixture was poured into a Brabender feed hopper and using the feed screw dosed gradually into the feed throat of a Rondol twin-screw extruder. The heating zones were set at temperatures of 140° C. (Zone 1), 200° C. (Zone 5), and 190° C. (Die) and the mixture was melt extruded to form an initial masterbatch comprising 4 wt. % ultra blue and 35 wt. % ammonium pentaborate tetrahydrate and ITO. The initial masterbatch was cooled using a chilled water bath and then pelletised into granules using an Accrapak 750/3 free-standing strand dry cut pelletiser. The pellets were collected and then dried for several hours using Drymaster apparatus to form a solid masterbatch.

The solid masterbatch pellets were taken and loaded into the feed hopper of a CW Clarke 25 Plastic Injection Moulding, a benchtop manually operated device, and plastic plaques containing mixed ammonium pentaborate tetrahydrate and ITO were produced. The plastic plaques had a blue ‘background’ colour.

IR radiation was applied to the plastic plaques using a Videojet VJ-3320 CO₂ laser and a white mark or image was formed. NIR radiation (both continuous and pulsed) was applied to the plastic plaques using a Macsa F-9020 (Continuous Wave) Fibre Laser and an IPG YLPN-30 (Pulsed) Fibre Laser and a white mark or image was formed. UV radiation was applied to the plastic plaques using a Coherent 355 nm UV laser and a white mark or image was formed.

### Example 24

500 g of AOM was combined with 4500 g of LDPE pellets and tumble blended to form a powdery pellet mixture. The solid mixture was poured into a Brabender feed hopper and using the feed screw dosed gradually into the feed throat of a Rondol twin-screw extruder. The heating zones were set at temperatures of 140° C. (Zone 1), 200° C. (Zone 5), and 190° C. (Die) and the mixture was melt extruded to for an initial masterbatch comprising 10 wt. % AOM. The initial masterbatch was cooled using a chilled water bath and then pelletised using an Accrapak 750/3 free-standing strand dry cut pelletiser. The pellets were collected and then dried for several hours using Drymaster apparatus to form a solid masterbatch comprising 10 wt. % AOM.

2 kg of solid masterbatch pellets were processed with 24.7 kg of Marlex HHM 5502BN Virgin HDPE and 13.3 kg of SIRENE HD E 80 PWP rHDPE (Post Consumer Recycled HDPE) as a 65:35 HDPE mix (Virgin HDPE:rHDPE mix) to produce 500 mL tall Boston round (TBR) plastic bottles using extrusion blow moulding. The plastic bottles formed contains 5 wt. % solid masterbatch and 0.5 wt. % AOM.

The plastic bottles were taken and filled with a water-based synthetic (plastic) fibre dye mixture. 5 mL of RIT dye daffodil Yellow 2118 was mixed with 495 ml of water in the 500 mL tall Boston round (TBR) plastic bottles. The plastic bottles were heated to 91° C. in a water bath for 5 hours and allowed to cool to room temperature. The dye mixture was decanted from the bottle which was washed and dried and the plastic bottle had a yellow ‘background’ colour.

IR radiation was applied to the plastic bottles using a Videojet VJ-3320 CO₂ laser and a dark grey/black mark or image was formed. NIR radiation (both continuous and pulsed) was applied to the plastic bottles using a Macsa F-9020 (Continuous Wave) Fibre Laser and an IPG YLPN-30 (Pulsed) Fibre Laser and a darkgrey/black mark or image was formed. UV radiation was applied to the plastic bottles using a Coherent 355 nm UV laser and a dark/grey mark or image was formed.

### Embodiments

1. A plastic product formed of a plastic material having a colour-forming compound incorporated therein, wherein the plastic product is a plastic preform or plastic packaging.
2. A plastic product formed of a plastic material having a colour-forming compound incorporated therein, the plastic product having been produced by bringing the colour-forming compound into contact with a plastic material to form a plastic material having the colour-forming compound incorporated therein, and forming the plastic material having the colour-forming compound incorporated therein into the plastic product, wherein the plastic product is a plastic preform or plastic packaging.
3. A plastic product formed of a plastic material having a colour-forming compound incorporated therein, the plastic product having been produced by forming a plastic material having the colour-forming compound incorporated therein into a plastic product, wherein the plastic product is a plastic preform or plastic packaging.
4. A plastic product displaying a mark or image, wherein the plastic product is formed of a plastic material having a colour-forming compound incorporated therein, wherein the plastic product is a plastic preform or plastic packaging.
5. A plastic product displaying a mark or image, said plastic product obtainable by applying radiation to a plastic product having a colour-forming compound incorporated therein such that the mark or image is formed where the radiation is applied to the plastic product, wherein the plastic product is a plastic preform or plastic packaging.
6. A method of forming a mark or image on a plastic product, the method comprising the plastic product to radiation to form the mark or image where the radiation is applied, wherein the plastic product is formed of a material having a colour-forming compound incorporated therein, wherein the plastic product is a plastic preform or plastic packaging.
7. A use of particles of a colour-forming compound in the formation of a mark or image on a plastic product formed of a plastic material having the colour-forming compound incorporated therein, wherein the plastic product is a plastic preform or plastic packaging.
8. A method of producing a plastic product formed of a plastic material having a colour-forming compound incorporated therein, the method comprising bringing the colour-forming compound into contact with a plastic material to form a plastic material having the colour-forming compound incorporated therein, and forming the plastic material having the colour-forming compound incorporated therein into the plastic product, wherein the plastic product is a plastic preform or plastic packaging.
9. A method of producing a plastic product formed of a plastic material having a colour-forming compound incorporated therein, the method comprising forming a plastic material having the colour-forming compound incorporated therein into a plastic product, wherein the plastic product is a plastic preform or plastic packaging.
10. A method of producing a plastic preform, and optionally a plastic bottle, the plastic preform or plastic bottle being formed of a plastic material having a colour-forming compound incorporated therein, the method comprising bringing the colour-forming compound into contact with a plastic material to form a plastic material having the colour-forming compound incorporated therein, and forming a plastic preform from the plastic material having the colour-forming compound incorporated therein, and optionally forming the plastic preform into a plastic bottle.
11. A method of producing a plastic preform, and optionally a plastic bottle, the plastic preform or plastic bottle being formed of a plastic material having a colour-forming compound incorporated therein, the method comprising forming a plastic preform from a plastic material having the colour-forming compound incorporated therein, and optionally forming the plastic preform into a plastic bottle, preferably forming the plastic bottle.
12. The plastic product or method according to any of embodiments 2, 3, or 8 to 11, wherein the plastic product, plastic preform or plastic bottle is further exposed to radiation to form a mark or image.
13. The plastic product or method according to any of embodiments 2, 3, or 8 to 12, wherein the plastic material is molten when the colour-forming compound is incorporated therein, or the plastic material having the colour-forming compound incorporated therein is molten, and preferably, the colour-forming compound is present as particles of colour-forming compound.
14. A use of a colour-forming compound in the production of a plastic material having the colour-forming compound incorporated therein or plastic product having a colour-forming compound incorporated therein, wherein the plastic product is a plastic preform or plastic packaging.
15. The plastic product, method or use according to any of embodiments 1 to 9, or embodiment 12 or 13 when dependent upon embodiments 8 or 9, and embodiment 14, wherein the plastic product is a plastic preform or plastic container, preferably a plastic container such as a plastic box, plastic pouch, plastic bottle, plastic blister packaging or plastic clamshell packaging, more preferably a plastic pouch or plastic bottle, and most preferably a plastic bottle.
16. The plastic product, method or use according to any of embodiments 1 to 15, wherein the colour-forming compound is present in the plastic product, plastic preform or plastic bottle in particulate form as particles of the colour-forming compound.
17. The plastic product, method or use according to any of embodiments 1 to 16, wherein the colour-forming compound is present in the plastic product in an amount of less than 15 wt. %, such as less than 12 wt. %, such as less than 10 wt. %, such as less than 5 wt % for example from 0.1 to 4 wt. %, such as less than 4 wt. % for example 0.1 to 3 wt. %, or less than 2 wt % for example from 0.1 to 1 wt. %, or wherein the plastic material used to form the plastic product comprises less than 15 wt. %, such as less than 12 wt. %, such as less than 10 wt. %, such as less than 5 wt % for example from 0.1 to 4 wt. %, such as less than 4 wt. % for example 0.1 to 3 wt. %, or less than 2 wt % for example from 0.1 to 1 wt. % of the colour-forming compound.
18. The plastic product, method or use according to any of embodiments 2, 8, and 10, and any of embodiments 12, 13, 14, 15 or 16 where dependent thereon, wherein the colour-forming compound is brought into contact with the plastic material in an amount of less than 15 wt. %, such as less than 12 wt. %, such as less than 10 wt. %, such as less than 5 wt % for example from 0.1 to 4 wt. %, such as less than 4 wt. % for example 0.1 to 3 wt. %, or less than 2 wt % for example from 0.1 to 1 wt. %, and optionally in the form of particles of the colour-forming compound.
19. A mixture comprising:
   (i) a colour-forming compound; and
   (ii) a plastic material.
20. A plastic material having a colour-forming compound incorporated therein.
21. The plastic material according to embodiment 19 or 20, wherein the colour-forming compound is present in an amount of less than 15 wt. %, such as less than 12 wt. %, such as less than 10 wt. %, such as less than 5 wt % for example from 0.1 to 4 wt. %, such as less than 4 wt. % for example 0.1 to 3 wt. %, or less than 2 wt % for example from 0.1 to 1 wt. %, and optionally present in the form of particles of colour-forming compound.
22. The plastic product, method, use, mixture or plastic material according to any of embodiments 1 to 21, wherein the plastic material comprises polyethylene terephthalate (PET), polybutylene terephthalate (PBT), poly cyclohexylenedimethylene terephthalate glycol-modified (PCTG), high density polyethylene (HDPE), polypropylene (PP), polyvinyl chloride (PVC), polyvinylidene chloride (PVDC), polychlorotrifluoroethylene (PCTFE), cyclic olefin copolymer (COC), recycled polyethylene terephthalate (r-PET), polyethylene terephthalate glycol (PET-G), polycarbonates (PC), poly(lactic acid) (PLA), polyethylene terephthlate (PET), polyhydroxyalkanoate (PHA), poly(glycolic acid) (PGA), low density polyethylene (LDPE) or polystyrene (PS), or combinations thereof, preferably polyethylene terephthalate (PET), polybutylene terephthalate (PBT), poly cyclohexylenedimethylene terephthalate glycol-modified (PCTG), high density polyethylene (HDPE), polypropylene (PP), polyvinyl chloride (PVC), recycled polyethylene terephthalate (r-PET), low density polyethylene (LDPE), polyethylene terephthalate glycol (PET-G), or polystyrene (PS), or combinations thereof, more preferably polyethylene terephthalate (PET), polybutylene terephthalate (PBT), poly cyclohexylenedimethylene terephthalate glycol-modified (PCTG), recycled polyethylene terephthalate (r-PET), polyethylene terephthalate glycol (PET-G), low-density polyethylene (LDPE), high-density polyethylene (HDPE), and polypropylene (PP), or combinations thereof, more preferably polyethylene terephthalate (PET), high-density polyethylene (HDPE), recycled polyethylene terephthalate (r-PET), polyethylene terephthalate glycol (PET-G), low density polyethylene (LDPE), polypropylene (PP), or combinations thereof, more preferably, polyethylene terephthalate (PET), recycled polyethylene terephthalate (r-PET) or polyethylene terephthalate glycol (PET-G), and more preferably, the plastic material comprises polyethylene terephthalate (PET).
23. The plastic product, method, use, mixture or plastic material according to any of embodiments 1 to 22, wherein the colour-forming compound is present as particles of colour-forming compound and the particles of colour-forming compound have a volume-weighted mean diameter D[4,3] of from 0.1 to 40 μm, preferably from 0.5 to 20 μm, more preferably from 1 to 15 μm, more preferably from 1 to 10 μm, more preferably from 1 to 7 μm, and most preferably from 3 to 7 μm.
24. The plastic product or method according to any of embodiments 5, 6, 12, and any of embodiments 13, 15, 16, 17, 18, 22 and 23 where dependent thereon, wherein the radiation is applied from a laser source(s), lamp or LED, preferably from a laser source(s).
25 The plastic product or method according to any of embodiments 5, 6, 12 and 24, and any of embodiments 13, 15, 16, 17, 18, 22 and 23 where dependent thereon, wherein the radiation is selected from ultraviolet (UV) radiation with a wavelength of from 10 to 400 nm, visible radiation with a wavelength of from 400 to 700 nm, infrared (IR) radiation with a wavelength of from 700 nm to 1 mm, including near-infrared (NIR) radiation with a wavelength of from 700 to 1600 nm, preferably the radiation is selected from UV radiation with a wavelength of 10 to 400 nm, IR radiation with a wavelength of from 700 nm to 1 mm, including near-infrared (NIR) radiation with a wavelength of from 700 to 1600 nm, more preferably the radiation is selected from UV radiation with a wavelength of 250 to 370 or 405 nm, infrared (IR) radiation with a wavelength of 9300, 9600, 10200 or 10600 nm (applied using a CO₂ laser), infrared radiation with a wavelength of from 700 nm to 1 mm, and near-infrared (NIR) radiation with a wavelength of 700 to 1600 nm, more preferably the radiation is selected from infrared (IR) radiation with a wavelength of 9300, 9600, 10200 or 10600 nm (applied using a CO₂ laser), infrared radiation with a wavelength of from 700 nm to 1 mm, and near-infrared (NIR) radiation with a wavelength of 700 to 1600 nm such as from 950 to 1100 nm, and more preferably, the radiation is infrared (IR) radiation with a wavelength of 10600 nm (applied using a CO₂ laser) and near-infrared (NIR) radiation with a wavelength of from 700 to 1600 such as from 950 to 1100 nm.
26. The plastic product, method, use, mixture, or plastic material according to any of embodiments 1 to 25, wherein the colour-forming compound is selected from an inorganic hydrate, potassium bicarbonate, kaolin, an oxyanion of a multivalent metal or oxyacid and/or hydrate thereof, a diacetylene and a leuco dye, or combination thereof.
27. The plastic product, method, use, mixture or plastic material according to embodiment 26, wherein the colour-forming compound is selected from sodium molybdate dihydrate, ammonium pentaborate tetrahydrate, ammonium pentaborate octahydrate, potassium bicarbonate, kaolin such as calcined kaolin, ammonium octamolybdate (AOM), a diacetylene and a leuco dye, or combination thereof.
28. The plastic product, method, use, mixture or plastic material according to embodiment 26 or 27, wherein the colour-forming compound is selected from calcined kaolin, ammonium octamolybdate (AOM) and a diacetylene, or combination thereof.
29. The plastic product, method, use, mixture, or plastic material according to any of embodiments 1 to 27, wherein the colour-forming compound is sodium molybdate dihydrate and preferably, the plastic material comprises PET, r-PET and/or PET-G.
30. The plastic product, method, use, mixture, or plastic material according to any of embodiments 1 to 27, wherein the colour-forming compound is potassium bicarbonate.
31. The plastic product, method, use, mixture or plastic material according to any of embodiments 1 to 27, wherein the colour-forming compound is ammonium pentaborate tetrahydrate.
32. The plastic product, method, use, mixture or plastic material according to any of embodiments 1 to 27, wherein the colour-forming compound is ammonium pentaborate octahydrate.
33. The plastic product, method, use, mixture, or plastic material according to any of embodiments 29 to 32, wherein the radiation used to form the mark or image is infrared (IR) radiation with a wavelength of from 700 nm to 1 mm, such as infrared (IR) radiation with a wavelength of 9300, 9600, 10200 or 10600 nm (applied using a CO₂ laser).
34. The plastic product, method, use, mixture, or plastic material according to any of embodiments 1 to 28, wherein the colour-forming compound is kaolin such as calcined kaolin and preferably, the plastic material comprises PET, r-PET and/or PET-G.
35. The plastic product, method, use, mixture, or plastic material according to embodiment 34, wherein the colour-forming compound is calcined kaolin.
36. The plastic product, method, use, mixture, or plastic material according to any of embodiments 1 to 28, wherein the colour-forming compound is an oxyanion of a multivalent metal or oxyacid, and/or hydrate thereof, preferably an ammonium salt of an oxyanion of molybdenum, and more preferably ammonium octamolybdate (AOM) and optionally, wherein the plastic material has a melting temperature lower than the decomposition temperature of the oxyanion of a multivalent metal or oxyacid and/or hydrate thereof, preferably wherein the plastic material comprises LDPE, HDPE and/or PP, most preferably HDPE.
37. The plastic product, method, use, mixture, or plastic material according to embodiment 36, wherein the colour-forming compound is an oxyanion of a multivalent metal or oxyacid, and/or hydrate thereof, preferably an ammonium salt of an oxyanion of molybdenum, and more preferably ammonium octamolybdate (AOM), and wherein the plastic material comprises LDPE, HDPE and/or PP, preferably HDPE.
38. The plastic product, method, use, mixture, or plastic material according to embodiment 36 or 37, wherein the colour-forming compound is ammonium octamolybdate (AOM) and the plastic material comprises LDPE, HDPE and/or PP, preferably HDPE.
39. The plastic product, method, use, mixture, or plastic material according to any of embodiments 1 to 28, wherein the colour-forming compound is an oxyanion of a multivalent metal or oxyacid, and/or hydrate thereof, preferably an ammonium salt of an oxyanion of molybdenum, and more preferably ammonium octamolybdate (AOM) and optionally, wherein the plastic material has a melting temperature higher than the decomposition temperature of the oxyanion of a multivalent metal or oxyacid and/or hydrate thereof, preferably wherein the plastic material comprises PET, r-PET and/or PET-G.
40. The plastic product, method, use, mixture, or plastic material according to any of embodiments 1 to 28, wherein the colour-forming compound is a diacetylene.
41. The plastic product, method, use, mixture, or plastic material according to embodiment 40, wherein the radiation is used to form the mark or image is UV radiation with a wavelength of from 10 to 400 nm such as from 250 to 370 or 405 nm, optionally followed by infrared (IR) radiation with a wavelength of from 700 nm to 1 mm including near-infrared (NIR) radiation with a wavelength of from 700 to 1600 nm, such as infrared (IR) radiation with a wavelength of 9300, 9600, 10200 or 10600 nm (applied using a CO₂ laser) or near-infrared (NIR) radiation with a wavelength of 700 to 1600 nm, such as from 950 to 1100 nm.
42. The plastic product, method, use, mixture, or plastic material according to any of embodiments 1 to 27, wherein the colour-forming compound is a leuco dye and the plastic material or plastic product further comprises an acid-generating agent.
43. The plastic product, method, use, mixture, or plastic material according to embodiment 42, wherein the plastic material has a melting temperature lower than at least one of the leuco dye and acid-generating agent.
44. The plastic product, method, use, mixture, or plastic material according to embodiment 42 or 43, wherein the leuco dye is selected from 6-(dimethylamino)-3,3-bis[4-(dimethylamino)phenyl]phthalide, 7-[4-(diethylamino)-2-ethoxyphenyl]-7-(2-methyl-1-octyl-1H-indol-3-yl) furo[3,4-b]pyridin-5 (7H)-one, 3,3′-bis(1-n-octyl-2-methylindol-3-yl) phthalide, N,N-dimethyl-4-[2-[2-(octyloxy)phenyl]-6-phenyl-4-pyridinyl]-benzenamine, 6′-(diethylamino)-2′-[(dimethylphenyl)amino]-3′-methylspiro[isobenzofuran-1(3H), 9′-[9H]xanthene]-3-one, 2′-anilino-6′-[ethyl(p-tolyl)amino]-3′-methylspiro[isobenzofuran-1(3H), 9′-[9H]xanthene]-3-one (CAS No. 59129-79-2), 4,4′-[(9-butyl-9H-carbazol-3-yl)methylene]bis[N-methyl-N-phenylaniline] (CAS No. 67707-04-4), 6′-(diethylamino)-3-oxo-spiro[isobenzofuran-1(3H),9′-(9H) xanthene]-2′carboxylic acid ethyl ester (CAS No. 154306-60-2), 2′-Anilino-6′-(dibutylamino)-3′-methyl-3H-spiro[2-benzofuran-1,9′-xanthen]-3-one (CAS No. 89331-94-2), 6′-(Diethylamino)-3′-methyl-2′-(phenylamino)spiro[2-benzofuran-3,9′-xanthene]-1-one (CAS No. 29512-49-0) and 2′-(dibenxylamino)-6′-(diethylamino) fluoran (CAS No. 34372-72-0), preferably Blue3-CVL 6-(dimethylamino)-3,3-bis-[4-(dimethylamino)phenyl) phthalide (CAS No 1522-42-7).
45. The plastic product, method, use, mixture, or plastic material according to any of embodiments 42 to 44, wherein the acid-generating agent is ammonium sulphate.
46. The plastic product, method, use, mixture, or plastic material according to any of embodiments 42 to 45, wherein the radiation used to form an image is infrared (IR) radiation with a wavelength of from 700 nm to 1 mm such as infrared (IR) radiation with a wavelength of 9300, 9600, 10200 or 10600 nm (applied using a CO₂ laser).
47. The plastic product, method, use, mixture, or plastic material according to any previous embodiment, wherein the plastic material or plastic product further comprises an NIR absorber, or an NIR absorber is brought into contain with the plastic material to form a plastic material further comprising an NIR absorber suitable for forming a plastic product further comprising an NIR absorber.
48. The plastic product, method, use, mixture, or plastic material according to embodiment 47, wherein the NIR absorber is present as particles of NIR absorber.
49. The plastic product, method, use, mixture, or plastic material according to embodiment 47, wherein the NIR absorber and colour-forming compound, and if present acid-generating agent, are present as combination particles.
50. The plastic product, method, use, mixture, or plastic material according to embodiment 49 where dependent upon embodiment 42 to 46, wherein the colour-forming compound is a leuco dye and the NIR absorber, leuco dye and acid-generating agent are present as combination particles.
51. The plastic product, method, use, mixture, or plastic material according to any of embodiments 47 to 50, wherein near-infrared (NIR) radiation with a wavelength of 700 to 1600 nm, such as from 950 to 1100 nm, is also selected as the radiation used to form the mark or image.

1. A plastic product formed of a plastic material having a colour-forming compound incorporated therein,
wherein the plastic product is a plastic preform or plastic packaging, and
wherein the colour-forming compound is selected from an inorganic hydrate, potassium bicarbonate, kaolin, or a combination thereof.

2. A plastic product formed of a plastic material having a colour-forming compound incorporated therein, the plastic product having been produced by forming a plastic material having the colour-forming compound incorporated therein into a plastic product,
wherein the plastic product is a plastic preform or plastic packaging, and
wherein the colour-forming compound is selected from an inorganic hydrate, potassium bicarbonate, kaolin, or a combination thereof.

3. A method of forming a mark or image on a plastic product, the method comprising exposing the plastic product to radiation to form the mark or image where the radiation is applied,
wherein the plastic product is formed of a material having a colour-forming compound incorporated therein,
wherein the plastic product is a plastic preform or plastic packaging, and
wherein the colour-forming compound is selected from an inorganic hydrate, potassium bicarbonate, kaolin, or a combination thereof.

4. A method of producing a plastic product formed of a plastic material having a colour-forming compound incorporated therein, the method comprising forming a plastic material having particles of the colour-forming compound incorporated therein into a plastic product,
wherein the plastic product is a plastic preform or plastic packaging, and
wherein the colour-forming compound is selected from an inorganic hydrate, potassium bicarbonate, kaolin, or a combination thereof.

5. A method of producing a plastic preform, and optionally a plastic bottle, the plastic preform or plastic bottle being formed of a plastic material having a colour-forming compound incorporated therein, the method comprising forming a plastic preform from a plastic material having the colour-forming compound incorporated therein, the colour-forming compound being selected from an inorganic hydrate, potassium bicarbonate, kaolin, or a combination thereof, and optionally forming the plastic preform into a plastic bottle.

6. The method according to claim 4, wherein the method further comprises the step of exposing the plastic product to radiation to form a mark or image, preferably using a laser source(s), lamp or LED.

7. The plastic product according to claim 1, wherein the plastic product is a plastic preform or plastic container, preferably a plastic container such as a plastic box, plastic pouch, plastic bottle, plastic blister packaging or plastic clamshell packaging, more preferably a plastic pouch or plastic bottle, and most preferably a plastic bottle.

8. The plastic product according to claim 1, wherein the colour-forming compound is present in the plastic product in an amount of less than 15 wt. %, such as less than 12 wt. %, such as less than 10 wt. %, such as less than 5 wt % for example from 0.1 to 4 wt. %, such as less than 4 wt. % for example 0.1 to 3 wt. %, or less than 2 wt % for example from 0.1 to 1 wt. %, or wherein the plastic material used to form the plastic product comprises less than 15 wt. %, such as less than 12 wt. %, such as less than 10 wt. %, such as less than 5 wt % for example from 0.1 to 4 wt. %, such as less than 4 wt. % for example 0.1 to 3 wt. %, or less than 2 wt % for example from 0.1 to 1 wt. % of the colour-forming compound.

9. The plastic product according to claim 1, wherein the plastic material comprises polyethylene terephthalate (PET), polybutylene terephthalate (PBT), poly cyclohexylenedimethylene terephthalate glycol-modified (PCTG), high density polyethylene (HDPE), polypropylene (PP), polyvinyl chloride (PVC), polyvinylidene chloride (PVDC), polychlorotrifluoroethylene (PCTFE), cyclic olefin copolymer (COC), recycled polyethylene terephthalate (r-PET), polyethylene terephthalate glycol (PET-G), polycarbonates (PC), poly(lactic acid) (PLA), polyethylene terephthalate (PET), polyhydroxyalkanoate (PHA), poly(glycolic acid) (PGA), low density polyethylene (LDPE) or polystyrene (PS), or combinations thereof, preferably polyethylene terephthalate (PET), polybutylene terephthalate (PBT), poly cyclohexylenedimethylene terephthalate glycol-modified (PCTG), high density polyethylene (HDPE), polypropylene (PP), polyvinyl chloride (PVC), recycled polyethylene terephthalate (r-PET), low density polyethylene (LDPE), polyethylene terephthalate glycol (PET-G), or polystyrene (PS), or combinations thereof, more preferably polyethylene terephthalate (PET), polybutylene terephthalate (PBT), poly cyclohexylenedimethylene terephthalate glycol-modified (PCTG), recycled polyethylene terephthalate (r-PET), polyethylene terephthalate glycol (PET-G), low-density polyethylene (HDPE), high-density polyethylene (HDPE), and polypropylene (PP), or combinations thereof, more preferably polyethylene terephthalate (PET), recycled polyethylene terephthalate (r-PET), polyethylene terephthalate glycol (PET-G), low-density polypropylene (LDPE), high-density propylene (HDPE), and polypropylene (PP, or combinations thereof, more preferably polyethylene terephthalate (PET), recycled polyethylene terephthalate (r-PET) or polyethylene terephthalate glycol (PET-G), and more preferably the plastic material comprises polyethylene terephthalate (PET).

10. The method according to claim 3, wherein the radiation is applied from a laser source(s), lamp or LED, preferably a laser source(s).

11. The method according to claim 3, wherein the radiation is selected from ultraviolet (UV) radiation with a wavelength of from 10 to 400 nm, visible radiation with a wavelength of from 400 to 700 nm, infrared (IR) radiation with a wavelength of from 700 nm to 1 mm, including near-infrared (NIR) radiation with a wavelength of from 700 to 1600 nm, preferably, the radiation is selected from UV radiation with a wavelength of 10 to 400 nm, IR radiation with a wavelength of from 700 nm to 1 mm, including near-infrared (NIR) radiation with a wavelength of from 700 to 1600 nm, more preferably the radiation is selected from UV radiation with a wavelength of 250 to 370 or 405 nm, infrared (IR) radiation with a wavelength of 9300, 9600, 10200 or 10600 nm (applied using a CO₂ laser), infrared radiation with a wavelength of from 700 nm to 1 mm, and near-infrared (NIR) radiation with a wavelength of 700 to 1600 nm, more preferably the radiation is selected from infrared (IR) radiation with a wavelength of 9300, 9600, 10200 or 10600 nm (applied using a CO₂ laser), infrared radiation with a wavelength of from 700 nm to 1 mm, and near-infrared (NIR) radiation with a wavelength of 700 to 1600 nm such as from 950 to 1100 nm, and more preferably the radiation is infrared (IR) radiation with a wavelength of 10600 nm (applied using a CO₂ laser) and near-infrared (NIR) radiation with a wavelength of from 700 to 1600 such as from 950 to 1100 nm.

12. (canceled)

13. The plastic product according to claim 1, wherein the colour-forming compound is selected from sodium molybdate dihydrate, ammonium pentaborate tetrahydrate, ammonium pentaborate octahydrate, potassium bicarbonate, kaolin such as calcined kaolin or a combination thereof.

14. The method according to claim 5, wherein the method further comprises the step of exposing the plastic preform or plastic bottle to radiation to form a mark or image, preferably using a laser source(s), lamp or LED.

15. The plastic product according to claim 2, wherein the plastic product is a plastic preform or plastic container, preferably a plastic container such as a plastic box, plastic pouch, plastic bottle, plastic blister packaging or plastic clamshell packaging, more preferably a plastic pouch or plastic bottle, and most preferably a plastic bottle.

16. The plastic product according to claim 2, wherein the colour-forming compound is present in the plastic product in an amount of less than 15 wt. %, such as less than 12 wt. %, such as less than 10 wt. %, such as less than 5 wt % for example from 0.1 to 4 wt. %, such as less than 4 wt. % for example 0.1 to 3 wt. %, or less than 2 wt % for example from 0.1 to 1 wt. %, or wherein the plastic material used to form the plastic product comprises less than 15 wt. %, such as less than 12 wt. %, such as less than 10 wt. %, such as less than 5 wt % for example from 0.1 to 4 wt. %, such as less than 4 wt. % for example 0.1 to 3 wt. %, or less than 2 wt % for example from 0.1 to 1 wt. % of the colour-forming compound.

17. The plastic product according to claim 2, wherein the plastic material comprises polyethylene terephthalate (PET), polybutylene terephthalate (PBT), poly cyclohexylenedimethylene terephthalate glycol-modified (PCTG), high density polyethylene (HDPE), polypropylene (PP), polyvinyl chloride (PVC), polyvinylidene chloride (PVDC), polychlorotrifluoroethylene (PCTFE), cyclic olefin copolymer (COC), recycled polyethylene terephthalate (r-PET), polyethylene terephthalate glycol (PET-G), polycarbonates (PC), poly(lactic acid) (PLA), polyethylene terephthlate (PET), polyhydroxyalkanoate (PHA), poly(glycolic acid) (PGA), low density polyethylene (LDPE) or polystyrene (PS), or combinations thereof, preferably polyethylene terephthalate (PET), polybutylene terephthalate (PBT), poly cyclohexylenedimethylene terephthalate glycol-modified (PCTG), high density polyethylene (HDPE), polypropylene (PP), polyvinyl chloride (PVC), recycled polyethylene terephthalate (r-PET), low density polyethylene (LDPE), polyethylene terephthalate glycol (PET-G), or polystyrene (PS), or combinations thereof, more preferably polyethylene terephthalate (PET), polybutylene terephthalate (PBT), poly cyclohexylenedimethylene terephthalate glycol-modified (PCTG), recycled polyethylene terephthalate (r-PET), polyethylene terephthalate glycol (PET-G), low-density polyethylene (HDPE), high-density polyethylene (HDPE), and polypropylene (PP), or combinations thereof, more preferably polyethylene terephthalate (PET), recycled polyethylene terephthalate (r-PET), polyethylene terephthalate glycol (PET-G), low-density polypropylene (LDPE), high-density propylene (HDPE), and polypropylene (PP, or combinations thereof, more preferably polyethylene terephthalate (PET), recycled polyethylene terephthalate (r-PET) or polyethylene terephthalate glycol (PET-G), and more preferably the plastic material comprises polyethylene terephthalate (PET).

18. The plastic product according to claim 2, wherein the colour-forming compound is selected from sodium molybdate dihydrate, ammonium pentaborate tetrahydrate, ammonium pentaborate octahydrate, potassium bicarbonate, kaolin such as calcined kaolin or a combination thereof.

19. The method according to claim 3, wherein the colour-forming compound is selected from sodium molybdate dihydrate, ammonium pentaborate tetrahydrate, ammonium pentaborate octahydrate, potassium bicarbonate, kaolin such as calcined kaolin or a combination thereof.

20. The method according to claim 4, wherein the colour-forming compound is selected from sodium molybdate dihydrate, ammonium pentaborate tetrahydrate, ammonium pentaborate octahydrate, potassium bicarbonate, kaolin such as calcined kaolin or a combination thereof.

21. The method according to claim 5, wherein the colour-forming compound is selected from sodium molybdate dihydrate, ammonium pentaborate tetrahydrate, ammonium pentaborate octahydrate, potassium bicarbonate, kaolin such as calcined kaolin or a combination thereof.
